(19) United States
(12) Patent Application Publication
(10) Pub. No.: US 2026/0247100 A1
(43) Pub. Date: Aug. 20, 2026

(54) Communications System Performance Monitoring with Time Series Overlay

(71) Applicant: Apple Inc., Cupertino, CA (US)

(72) Inventors: Daniel V. Chioreanu, Royal Oak, MI (US); Jarett M. Morrow, Mountain View, CA (US); Javier Revillas, El Espinar (ES); Justin M. Hendryx, San Francisco, CA (US)

(21) Appl. No.: 19/540,209

(22) Filed: Feb. 13, 2026

Related U.S. Application Data
(60) Provisional application No. 63/759,947, filed on Feb. 18, 2025.

(51) Int. Cl. H04W 4/021; H04W 24/10; H04W 64/00; H04W 84/06

(52) U.S. Cl. CPC H04W 4/021; H04W 24/10; H04W 64/00; H04W 84/06

(57) ABSTRACT

A communications system may include a core network (CN) that communicates with a set of user equipment (UE) devices in a geographic region via a constellation of satellites. The CN may receive signal measurements associated with radio-frequency signals conveyed between the constellation and the UE devices during a series of sub-periods of a predetermined time period. The CN may generate a time series of accumulated data by accumulating the received wireless performance metric data for different locations within the geographic region across the predetermined time period. The CN may identify an area of interest (AOI) based on the accumulated data. The AOI may correspond to a portion of the geographic region associated with accumulated data that is within or outside of a predetermined range of values. The CN may perform one or more actions based on the accumulated data and/or the AOI.

### CROSS REFERENCE TO RELATED APPLICATION

This application claims the benefit of U.S. provisional patent application No. 63/759,947, filed Feb. 18, 2025, which is hereby incorporated by reference herein in its entirety.

### FIELD

This relates generally to wireless communications, including wireless communications by electronic devices.

### BACKGROUND

Communications systems are used to convey data between terminals such as user equipment (UE) devices. Some communications systems include satellites that wirelessly convey data between user equipment devices and gateways. It can be challenging to ensure that communications systems such as these are able to exhibit satisfactory levels of performance over time.

### SUMMARY

A communications system may include a core network (CN) that communicates with a set of user equipment (UE) devices in a geographic region via a constellation of communications satellites and at least one gateway. The CN may receive signal measurements associated with radio-frequency signals conveyed between the constellation and the UE devices during a series of sub-periods of a predetermined time period. The signal measurements may include wireless performance metric data. The CN may generate a time series of accumulated data by accumulating the received wireless performance metric data for different locations within the geographic region across the predetermined time period.

The CN may identify an area of interest (AOI) based on the accumulated data. The AOI may correspond to a portion of the geographic region associated with accumulated data that is within or outside of a predetermined range of values. The CN may perform one or more actions based on the accumulated data and/or the AOI. The actions may include outputting a report, displaying a signal map, filtering out signal measurements of the AOI from the accumulated data, adjusting a shape of the AOI based on a portion of the geographic area having stronger accumulated data, issuing an alert and/or updating an alert policy based on the AOI, and/or causing one or more adjustments to how the constellation conveys radio-frequency signals with the UE devices in the geographic region.

The CN may generate the signal map with a graphical indicator of the geographic region. During each sub-period, the CN may associate one or more polygons derived from ephemeris data (sometimes referred to as beam polygons) with wireless performance metric data that is within a predetermined range of values during that sub-period. The CN may project the beam polygons onto the signal map. Each beam polygon may span a respective set of locations in the signal map. The beam polygons may have a graphical property such as a color, shade, or opacity level proportional to the wireless performance metric data gathered for its set of locations during the corresponding sub-period. As beam polygons are overlaid with each other after additional sub-periods have elapsed, the graphical property may increment, accumulate, or change within an overlap region of the beam polygons. The CN may, for example, identify the AOI as a region where at least a threshold number of the beam polygons overlap after the predetermined time period has elapsed. If desired, the beam polygons may be replaced with a repeating pattern of cells across the geographic area. Alternatively, the signal map may be a heat map of an accumulated continuous variable in the wireless performance metric data. A communications interface of the CN may output the signal map for display by an electronic device.

An aspect of the disclosure provides a method of operating one or more servers. The method can include receiving, using a communications interface, first signal measurements of radio-frequency signals that were conveyed, during a first time period, within a geographic region by a constellation of communications satellites. The method can include receiving, using the communications interface, second signal measurements of radio-frequency signals that were conveyed, during a second time period, within the geographic region by the constellation of communications satellites. The method can include generating, using processing circuitry, accumulated signal measurements by combining the first signal measurements with the second signal measurements. The method can include identifying, using the processing circuitry, an area of interest (AOI) based on the accumulated signal measurements. The method can include performing, using the processing circuitry, an action based on the identified AOI.

An aspect of the disclosure provides a method of operating a server. The method can include receiving, using a communications interface, first signal measurements of radio-frequency signals that were conveyed, during a first time period, within a geographic region by a constellation of communications satellites. The method can include generating, using processing circuitry, a signal map of the geographic region, wherein the signal map includes a first graphical indicator that overlaps the geographic region, the first graphical indicator having a first value of a graphical property that is based on the first signal measurements. The method can include receiving, using a communications interface, second signal measurements of radio-frequency signals that were conveyed, during a second time period, within the geographic region by the constellation of communications satellites. The method can include updating, using the processing circuitry, the signal map to include a second graphical indicator overlapping the geographic region, wherein the second graphical indicator has a second value of the graphical property that is based on the second signal measurements. The method can include transmitting, using the communications interface, the signal map to an electronic device having a display that displays the signal map.

An aspect of the disclosure provides a method of operating a core network in communication with a set of user equipment (UE) devices in a geographic region via a constellation of communications satellites and at least one gateway. The method can include receiving, using a communications interface, wireless performance metric data associated with radio-frequency signals conveyed between the constellation of communications satellites and the UE devices during a series of sub-periods of a predetermined time period, wherein each sub-period in the series comprises at least one system cycle of the constellation of communications satellites and the predetermined time period is at least one minute. The method can include generating, using processing circuitry, accumulated data by accumulating the wireless performance metric data for different locations within the geographic region across the predetermined time period. The method can include causing, using the processing circuitry and the communications interface, an adjustment to communications via the constellation of communications satellites based on the accumulated data.

### BRIEF DESCRIPTION OF THE DRAWINGS

FIG. 1 is a diagram of an illustrative communications system including user equipment devices that communicate with gateways via a constellation of communications satellites in accordance with some embodiments.

FIG. 2 is a schematic diagram of an illustrative user equipment device in accordance with some embodiments.

FIG. 3 is a schematic diagram of an illustrative communications satellite in accordance with some embodiments.

FIG. 4 is a schematic diagram of an illustrative network performance monitoring device in accordance with some embodiments.

FIG. 5 is a schematic diagram of an illustrative core network in accordance with some embodiments.

FIG. 6 is a flow chart of illustrative operations involved in monitoring performance of a communications system using a time series overlay of signal measurements in accordance with some embodiments.

FIG. 7 is a flow chart of illustrative operations involved in displaying a signal map of signal measurements in accordance with some embodiments.

FIG. 8 is a diagram showing how an illustrative signal map may be generated to display an area of interest based on overlapping polygons of signal measurements in accordance with some embodiments.

FIG. 9 is a diagram showing how an illustrative area of interest in a signal map may be constrained by another area of the signal map in accordance with some embodiments.

FIG. 10 is a diagram showing how an illustrative signal map may be generated to display an area of interest based on a grid of signal measurements in accordance with some embodiments.

### DETAILED DESCRIPTION

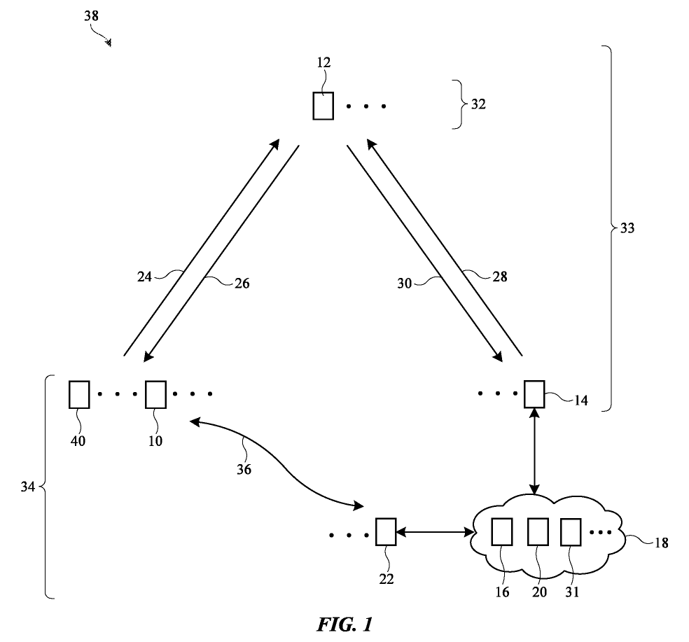

FIG. 1 is a diagram of an illustrative communications system 38. Communications system 38 (sometimes referred to herein as communications network 38, network 38, system 38, satellite communications system 38, or satellite communications network 38) may include a ground-based (terrestrial) gateway system that includes one or more gateways 14 and may include one or more user equipment (UE) devices 10. Gateways 14 and UE devices 10 may form a part of a terrestrial network 34 on Earth. Terrestrial network 34 may include terrestrial-based wireless communications equipment 22 and network portion 18. Terrestrial-based wireless communications equipment 22 may include, for example, one or more wireless base stations (e.g., for implementing a cellular telephone network), wireless access points (e.g., for implementing a wireless local area network (WLAN)), and/or other UE devices (e.g., for implementing a device-to-device (D2D) network, a wireless personal area network (WPAN), etc.).

Communications system 38 may include a constellation 32 of one or more communications satellites 12. UE devices 10, gateways 14, and constellation 32 may form a part of non-terrestrial network (NTN) 33, which conveys signals between UE devices 10 and gateways 14 via constellation 32. Constellation 32 is sometimes also referred to herein as satellite constellation 32. Communications satellites 12 are located in space (e.g., in orbit around Earth). Communications system 38 may include any desired number of gateways 14, any desired number of communications satellites 12, and any desired number of UE devices 10. Only a single gateway 14, a single communications satellite 12, and a single UE device 10 are illustrated in FIG. 1 for the sake of simplicity. Each gateway 14 in communications system 38 may be located at a different respective geographic location on Earth (e.g., across different regions, cities, counties, prefectures, districts, municipalities, land masses, areas, localities, states, provinces, countries, continents, etc.).

Network portion 18 (sometimes also referred to herein simply as network 18) may be communicatively coupled to terrestrial-based wireless communications equipment 22 and each of the gateways 14 in communications system 38. Gateway (GW) 14 may include a satellite network ground station and may therefore sometimes also be referred to as ground station (GS) 14 or satellite network ground station 14. Each gateway 14 may include one or more electronic devices such as servers that interface between constellation 32 and network portion 18. Each gateway 14 may also include wireless equipment communicatively coupled to the device(s). The wireless equipment may include antennas (e.g., electronically and/or mechanically adjustable antennas), modems, transceivers, amplifiers, beam forming circuitry, control circuitry (e.g., one or more processors, storage circuitry, etc.), and other components that are used to convey communications data. The components of each gateway 14 may, for example, be disposed at a respective geographic location (e.g., within the same computer, server, data center, building, etc.). Gateways 14 may convey communications data between terrestrial network 34 and UE devices 10 via satellite constellation 32.

Network portion 18 may include any desired number of network nodes (e.g., terminals, devices, end hosts, etc.) that are communicatively coupled together using communications paths that include wired and/or wireless links. The wired links may include cables (e.g., ethernet cables, optical fibers or other optical cables that convey signals using light, telephone cables, etc.). Network portion 18 may include one or more relay networks, mesh networks, local area networks (LANs), wireless local area networks (WLANs), ring networks (e.g., optical rings), cloud networks, virtual/logical networks, the Internet, combinations of these, and/or any other desired network nodes coupled together using any desired network topologies (e.g., on Earth). The network nodes, terminals, and/or end hosts may include network switches, network routers, optical add-drop multiplexers, other multiplexers, repeaters, modems, servers, network cards, wireless access points, wireless base stations, UE devices such as UE devices 10, and/or any other desired network components. The network nodes in network portion 18 may include physical components such as electronic devices, servers, computers, user equipment, etc., and/or may include virtual components that are logically defined in software and that are distributed across (over) two or more underlying physical devices (e.g., in a cloud network configuration).

Network portion 18 may include one or more satellite network operations centers such as network operations center (NOC) 16. NOC 16 may control the operation of gateways 14 in communicating with satellite constellation 32. NOC 16 may also control the operation of the satellites in satellite constellation 32. For example, NOC 16 may convey control commands via gateways 14 that control positioning operations (e.g., orbit adjustments), sensing operations (e.g., thermal information gathered using one or more thermal sensors), and/or any other desired operations performed in space by satellites 12. NOC 16, gateways 14, and satellite constellation 32 may be operated or managed by a corresponding satellite constellation operator.

Communications system 38 may also include a satellite communications (satcom) network service provider (e.g., a satcom network carrier or operator) for controlling wireless communications between UE devices 10 and terrestrial network 34 via satellite constellation 32. The satcom network service provider may be a different entity than the satellite constellation operator that controls/operates NOC 16, gateways 14, and satellite constellation 32, or may be the same entity as the satellite constellation operator. Terrestrial-based wireless communications equipment 22 in terrestrial network 34 may be operated by one or more terrestrial network carriers or service providers. The terrestrial network carriers or service providers may be different entities than the satcom network service provider or, if desired, may be the same entity as the satcom network service provider.

One or more gateways 14 may control the operations of satellite constellation 32 over corresponding radio-frequency communications links. Satellite constellation 32 may include any desired number of satellites (e.g., two satellites, four satellites, ten satellites, dozens of satellites, hundreds of satellites, thousands of satellites, etc.), one of which is shown in FIG. 1. If desired, two or more of the satellites in satellite constellation 32 may convey radio-frequency signals between each other using satellite-to-satellite (e.g., relay) links.

Constellation 32 may include a set of non-geostationary orbit (NGSO) satellites 12 (e.g., satellites in non-geostationary orbits) and, if desired, may include a set of geostationary orbit (GSO) satellites 12 (e.g., satellites in geostationary/geosynchronous orbits, sometimes referred to as geosynchronous satellites or GEO satellites). GSO satellites in constellation 32 may orbit Earth at orbital altitudes of greater than around 30,000 km. NGSO satellites in constellation 32 may include low earth orbit (LEO) satellites at orbital altitudes of less than around 8,000 km (e.g., satellites in low earth orbits, inclined low earth orbits, low earth circular orbits, etc.), medium earth orbit (MEO) satellites at orbital altitudes between around 8,000 km and 30,000 km (e.g., satellite in medium earth orbits), sun synchronous satellites (e.g., satellites in sun synchronous orbits), satellites in tundra orbits, satellites in Molniya orbits, satellites in polar orbits, and/or satellites in any other desired non-geosynchronous orbits around Earth. If desired, satellites 12 may include multiple sets of satellites each in a different type of orbit and/or each at a different orbital altitude. In general, constellation 32 may include satellites in any desired combination of orbits or orbit types.

The satellites 12 in constellation 32 may communicate with one or more UE devices 10 on Earth using one or more radio-frequency communications links (e.g., satellite-to-user equipment links). Satellites 12 may also communicate with gateways 14 on Earth using radio-frequency communications links (e.g., satellite-to-gateway links). Radio-frequency signals may be conveyed between UE devices 10 and satellites 12 and between satellites 12 and gateways 14 in IEEE bands such as the IEEE C band (4-8 GHz), S band (2-4 GHz), L band (1-2 GHz), X band (8-12 GHz), W band (75-110 GHz), V band (40-75 GHz), K band (18-27 GHz), Kₐ band (26.5-40 GHz), Kᵤ band (12-18 GHz), and/or any other desired satellite communications (satcom) bands. If desired, different bands may be used for the satellite-to-user equipment links than for the satellite-to-gateway links.

Communications may be performed between gateways 14 and UE devices 10 in a forward (FWD) link direction and/or in a reverse (REV or RWD) link direction. In the forward link direction (sometimes referred to simply as the forward link), wireless data is conveyed from gateways 14 to UE device(s) 10 via constellation 32. Wireless data conveyed over the forward link is sometimes referred to herein as forward link data. Forward link data may be organized into a set, series, or stream of forward link datagrams (e.g., having header fields that contain header information, payload fields that contain a forward link data payload, etc.). A gateway 14 may, for example, transmit forward link data to one of the satellites 12 in satellite constellation 32 (e.g., where forward link datagrams are modulated onto one or more carriers of radio-frequency signals 28). Satellite 12 may transmit (e.g., relay, in a bent-pipe configuration) the forward link data received from gateway 14 to UE device(s) 10 (e.g., using radio-frequency signals 26). Radio-frequency signals 28 are conveyed in an uplink direction from gateway 14 to satellite 12 and are therefore sometimes also referred to herein as uplink (UL) signals 28, forward link UL signals 28, or forward link signals 28. Radio-frequency signals 26 are conveyed in a downlink direction from satellite 12 to UE device(s) 10 and are therefore sometimes also referred to herein as downlink (DL) signals 26, forward link DL signals 26, or forward link signals 26.

In the reverse link direction (sometimes referred to simply as the reverse link), wireless data is conveyed from UE device(s) 10 to gateways 14 via satellite constellation 32. Wireless data conveyed over the reverse link is sometimes referred to herein as reverse link data. Reverse link data may be organized into a set, series, or stream of reverse link datagrams (e.g., having header fields that contain header information, payload fields that contain a reverse link data payload, etc.). One of UE devices 10 may, for example, transmit reverse link data to one of the satellites 12 in constellation 32 (e.g., where reverse link datagrams are modulated onto one or more carriers of radio-frequency signals 24). Satellite 12 may transmit (e.g., relay, in a bent-pipe configuration) the reverse link data received from UE device 10 to a corresponding gateway 14 using radio-frequency signals 30. Radio-frequency signals 24 are conveyed in an uplink direction from UE device 10 to satellite 12 and are therefore sometimes also referred to herein as uplink (UL) signals 24, reverse link UL signals 24, or reverse link signals 24. Radio-frequency signals 30 are conveyed in a downlink direction from satellite 12 to gateway 14 and are therefore sometimes also referred to herein as downlink (DL) signals 30, reverse link DL signals 30, or reverse link signals 30. Gateway 14 may forward wireless data between UE device(s) 10 and network portion 18. Network portion 18 may forward the wireless data to any desired network nodes or terminals of terrestrial network 34.

If desired, UE devices 10 may also convey radio-frequency signals with terrestrial-based wireless communications equipment 22 over terrestrial network wireless communication links 36 when available. UE devices 10 may sometimes be referred to herein as being “online” or “on-grid” when the UE devices are within range of terrestrial-based wireless communications equipment 22 and when terrestrial-based wireless communications equipment 22 provides access (e.g., communications resources) to network portion 18 for the UE devices. When the UE devices are online, the UE devices may communicate with other network nodes or terminals in network portion 18 via terrestrial network wireless communications links 36. Conversely, UE devices 10 may sometimes be referred to herein as being “offline” or “off-grid” when the UE devices are out of range of terrestrial-based wireless communications equipment 22 or when terrestrial-based wireless communications equipment 22 does not provide access to network portion 18 for the UE devices (e.g., when terrestrial-based wireless communications equipment 22 is disabled due to a power outage, natural disaster, traffic surge, or emergency, when terrestrial-based wireless communications equipment 22 denies access to network portion 18 for the UE devices, when terrestrial-based wireless communications equipment 22 is overloaded with traffic, etc.).

If desired, UE devices 10 may include separate antennas for handling communications over the satellite-to-user equipment link and one or more terrestrial network wireless communication links 36 or UE devices 10 may include a single antenna that handles both the satellite-to-user equipment link and the terrestrial network wireless communications links. The terrestrial network wireless communications links may be, for example, cellular telephone links (e.g., links maintained using a cellular telephone communications protocol such as a 4G Long Term Evolution (LTE) protocol, a 3G protocol, a 3GPP Fifth Generation (5G) New Radio (NR) protocol, etc.), wireless local area network links (e.g., Wi-Fi® links), wireless personal area network links (e.g., Bluetooth links), D2D links, etc.

The wireless data carried by DL signals 26 is sometimes also referred to herein as DL data, forward link DL data, or forward link data. UL signals 28 may also carry the forward link data (e.g., forward link data that is routed by satellite 12 to UE device(s) 10 in DL signals 26). The wireless data carried by UL signals 24 is sometimes also referred to herein as UL data, reverse link UL data, or reverse link data. The reverse link data may be generated and transmitted by UE device(s) 10. DL signals 30 may also carry the reverse link data. Forward link data may be generated by any desired network nodes or terminals of terrestrial network 34. Forward link data and the reverse link data may include text data such as email messages, text messages, web browser data, an emergency or SOS message, a location message identifying the location of UE device(s) 10, or other text-based data, audio data such as voice data (e.g., for a bi-directional satellite voice call) or other audio data (e.g., streaming satellite radio data), video data (e.g., for a bi-directional satellite video call or to stream video data transmitted by gateway 14 at UE device(s) 10), cloud network synchronization data, data generated or used by software applications running on UE device(s) 10 (e.g., application data), data for use in a distributed processing network, and/or any other desired data. UE devices 10 may only receive forward link data, may only transmit reverse link data, or may both transmit reverse link data and receive forward link data. Each satellite 12 may communicate with the UE devices 10 located within its coverage area at any given time (e.g., UE devices 10 located within cells on Earth that overlap the signal beam(s) producible by the satellite).

The satcom network service provider for communications system 38 may operate, control, and/or manage a satcom control network such as core network (CN) 20 in network portion 18. CN 20 may sometimes also be referred to herein as satcom network region 20, CN region 20, satcom controller 20, satcom network 20, or satcom service provider equipment 20. CN 20 may be implemented on one or more network nodes and/or terminals of network portion 18 (e.g., one or more servers or other end hosts). In some implementations, CN 20 may be formed from a cloud computing network distributed over multiple underlying physical network nodes and/or terminals distributed across one or more geographic regions. CN 20 may therefore sometimes also be referred to herein as a CN cloud region or satcom network cloud region.

CN 20 may control and coordinate wireless communications between terminals (e.g., end hosts) of terrestrial network 34 and UE devices 10 via satellite constellation 32. For example, gateways 14 may receive reverse link data from UE devices 10 via satellite constellation 32 and may route the reverse link data to CN 20. CN 20 may perform any desired processing operations on the reverse link data. For example, CN 20 may identify destinations for the reverse link data and may forward the reverse link data to the identified destinations. CN 20 may also receive forward link data for transmission to UE devices 10 from one or more terminals or end hosts of terrestrial network 34 (e.g., network portion 18). CN 20 may process the forward link data to schedule the forward link data for transmission to UE devices 10 via satellite constellation 32. CN 20 may schedule the forward link data for transmission to UE devices 10 by generating forward link traffic grants for each of the UE devices that are to receive forward link data. CN 20 may provide the forward link data and the forward link traffic grants to gateways 14. Gateways 14 may transmit the forward link data to UE devices 10 via satellite constellation 32 according to the forward link traffic grants (e.g., according to a forward link communications schedule that implements the forward link traffic grants).

Network portion 18 may include one or more networks 31 that provide wireless data and/or services to UE device 10. Network 31 may include one or more servers. Network 31 may include, for example, a content delivery network (CDN) that provides content to CN 20 for delivery to UE device 10 (e.g., via terrestrial-based wireless communications equipment 22 while UE device 10 is on grid or in forward link data routed via constellation 32 while UE device 10 is off grid). If desired, network 31 may receive wireless data from UE device 10 via CN 20 (e.g., via terrestrial-based wireless communications equipment 22 while UE device 10 is on grid or via constellation 32 while UE device 10 is off grid). Network 31 may be the intended recipient of the wireless data or may forward the wireless data to an intended recipient (e.g., another server or network, another UE device, etc.). If desired, network 31 may include a network associated with one or more software applications running on UE device 10.

The time resources used for communications between CN 20 and a UE device 10 may be divided into a series of repeating system cycles over time (sometimes also referred to as system frames). Each system cycle may include a respective downlink (forward link) cycle and/or a respective uplink (reverse link) cycle. During each forward link cycle, CN 20 may transmit a broadcast message to each of the UE devices 10 served by a given satellite 12 via that satellite 12. CN 20 may also transmit one or more unicast messages (e.g., containing forward link data) to one or more of the UE devices 10 during the forward link cycle (e.g., during a portion of the forward link cycle not occupied by the broadcast message). During a reverse link cycle, a UE device 10 may transmit a reverse link message (e.g., containing reverse link data) to CN 20 via its serving satellite 12. The reverse link message may include, for example, one, two, or more than two reverse link datagrams. The reverse link cycle may have the same duration as the forward link cycle or may have a different duration. Each system cycle may have a duration (period) of between 2 seconds and 3 seconds (e.g., 2.56 seconds), between 1 second and 10 seconds, between 1 second and 5 seconds, greater than 1 second, greater than 2 seconds, less than 5 seconds, less than 10 seconds, or other durations. This is illustrative and, in general, the embodiments described herein may apply to any desired underlying satellite network technologies having any desired system cycles and having communications with any desired division of time and/or frequency resources.

In practice, the network performance of communications system 38 in conveying wireless data between UE device(s) 10 and gateway(s) 14 may vary over time. This variation can be due to variations in the performance of one or more components on UE device(s) 10, satellite constellation 32, and/or gateway(s) 14, as well as changes in the radio-frequency propagation/channel conditions between UE device(s) 10 and satellite constellation 32 and/or between satellite constellation 32 and gateway(s) 14 (e.g., due to changes in weather, atmospheric conditions, or other radio-frequency obstacles). It can be particularly difficult to monitor network performance in communications system 38 given that satellite constellation 32 is located in space and is generally unreachable for physical repair or in-person diagnostics, satellites 12 and UE devices 10 frequently or constantly move relative to Earth and each other over time, satellite constellation 32 might be operated by a satellite constellation operator that is different from the satcom network service provider, and different users may have/operate UE devices 10 having different hardware capabilities or conditions.

It would therefore be desirable for the satcom network service provider associated with CN 20 to be able to reliably monitor the wireless performance of communications system 38 in conveying wireless data via satellite constellation 32 in real-time. This may, for example, allow the satcom network service provider to identify errors or problems in the conveyance of wireless data between gateway(s) 14 and UE device(s) 10 via satellite constellation 32, to provide information identifying the errors or problems to an operator of gateway(s) 14 and/or NOC 16, to perform adjustments to one or more components in communications system 38 to correct the errors or problems, to ensure that NOC 16 or the satellite constellation operator is in compliance with any guarantee, contract, or agreement (e.g., a Service Level Agreement (SLA)) in place with the satcom network service provider regarding wireless communications capabilities that are to be provided to UE device(s) 10 via satellite constellation 32, to ensure that sufficient levels of service are provided to corresponding geographic regions, etc.

If desired, communications system 38 may include one or more network performance monitoring devices 40 that monitor the performance of communications system 38 in conveying wireless data via satellite constellation 32 in real-time. In some implementations, network performance monitoring devices 40 may be different from UE devices and may not be owned by, operated by, controlled by, and/or known to an end user. In these implementations, network performance monitoring devices 40 may be associated with (e.g., owned by, operated by, controlled by, and/or known to) the satcom network service provider associated with CN 20 and/or another entity. Alternatively, some or all of network performance monitoring devices 40 may be owned, controlled, and/or operated by end users. Network performance monitoring devices 40 may be distributed across different locations on Earth (e.g., in different regions, states, countries, cities, or areas that are to be provided with communications capacity by satellite constellation 32).

Network performance monitoring devices 40 may help to monitor the network performance of satellite constellation 32 and/or gateway(s) 14 in conveying wireless data for UE device(s) 10 based on forward link signals and/or reverse link signals conveyed by satellite constellation 32. Network performance monitoring devices 40 may, for example, receive the DL signals 26 transmitted to UE device(s) 10 by satellite constellation 32 (e.g., forward link data in DL signals 26) and/or may transmit some of the UL signals 24 to satellite constellation 32 (e.g., reverse link data in UL signals 24). Network performance monitoring devices 40 may generate and transmit information about the received forward link data (e.g., forward link signal measurements, which may include the received forward link data itself and/or wireless performance metric data) and/or information about the transmitted reverse link data (e.g., reverse link signal measurements, which may include the transmitted reverse link data itself and/or wireless performance metric data) to CN 20 (e.g., via the terrestrial network and/or the satellite constellation). While conveying wireless data with UE device(s) 10 via satellite constellation 32, gateway(s) 14 may also generate and transmit information about reverse link data received in DL signals 30 (e.g., reverse link signal measurements, which may include the received reverse link data itself and/or wireless performance metric data) to CN 20 (e.g., via the terrestrial network). If desired, a network performance monitoring device 40 may perform some or all of the same device functions and operations as a UE device 10.

The information about the forward link data received by network performance monitoring device(s) 40, the information about the reverse link data transmitted by network performance monitoring device(s) 40, and/or the information about the reverse link data received by gateway(s) 14 are sometimes referred to herein simply as signal measurements and may include measurements of one or more wireless performance metrics (sometimes also referred to as key performance indicators (KPIs)). Measurements of wireless performance metrics are sometimes also referred to herein as wireless performance metric data, wireless performance metric measurements, KPI data, or KPI measurements. Wireless performance metric data characterizes the radio-frequency (wireless) performance of one or more nodes of NTN 33 in transmitting and/or receiving reverse link and/or forward link signals. As just a few non-limiting examples, the wireless performance metric data may include received power levels, received signal strength indicator (RSSI) values, channel quality values, error rate values (e.g., bit error rate values, block error rate values, frame error rate values, etc.), signal quality values, signal-to-noise ratio (SNR) values, noise levels, noise floor values, signal-to-interference-plus-noise ratio (SINR) values, data rate values, sensitivity values, adjacent channel leakage ratio values, timing information, transmit power levels, error vector magnitude (EVM) values, received signal code power (RSCP) values, and/or any other desired wireless performance metric data. The signal measurements that are transmitted to CN 20 may also include some or all of the wireless data that has been transmitted and/or received by the measuring device (e.g., transmitted and/or received forward link data and/or reverse link data, transmitted and/or received forward link datagrams and/or reverse link datagrams, etc.). If desired, one or more UE devices 10 may also perform signal measurements associated with reverse link signal transmission and/or forward link signal reception and may transmit the signal measurements (e.g., wireless performance metric data and/or transmitted/received wireless data) to CN 20 via NTN 33 and/or terrestrial-based wireless communications equipment 22 for use in network performance monitoring.

CN 20 may process signal measurements received from network performance monitoring device(s) 40, gateway(s) 14, and/or UE device(s) 10 to monitor (e.g., detect, sense, identify, characterize, and/or analyze) the performance of communications system 38 in conveying wireless data between gateway(s) 14 and UE device(s) 10 via satellite constellation 32. This may include, for example, identifying (e.g., detecting) errors, problems, or other non-idealities in satellite constellation 32 and/or gateway(s) 14 that limit, deteriorate, or otherwise impact the performance of communications system 38 in conveying wireless data between gateway(s) 14 and UE device(s) 10 via satellite constellation 32. This may, if desired, include identifying one or more points in communications system 38 that produced or are likely to have produced the identified errors, problems, or other non-idealities and/or may include transmitting information (e.g., reports) to NOC 16 and/or an operator of gateway(s) 14 identifying the errors, problems, or other non-idealities and/or the points in communications system 38 that produced or are likely to have produced the identified errors. If desired, CN 20 may generate and output an alert and/or report that identifies some or all of this information. This monitoring may also include, if desired, generating commands or control signals that instruct NOC 16, gateway(s) 14, and/or satellite constellation 32 to perform one or more adjustments to how wireless data and/or radio-frequency signals are conveyed with UE device(s) 10 (e.g., one or more adjustments to signal transmission and/or reception, satellite positioning, etc.).

UE device 10 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user’s head (e.g., a virtual, mixed, and/or augmented reality headset, glasses, goggles, or helmet), a ring device worn on a user’s finger, or another type of wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless access point, equipment that implements the functionality of two or more of these devices, or other electronic equipment.

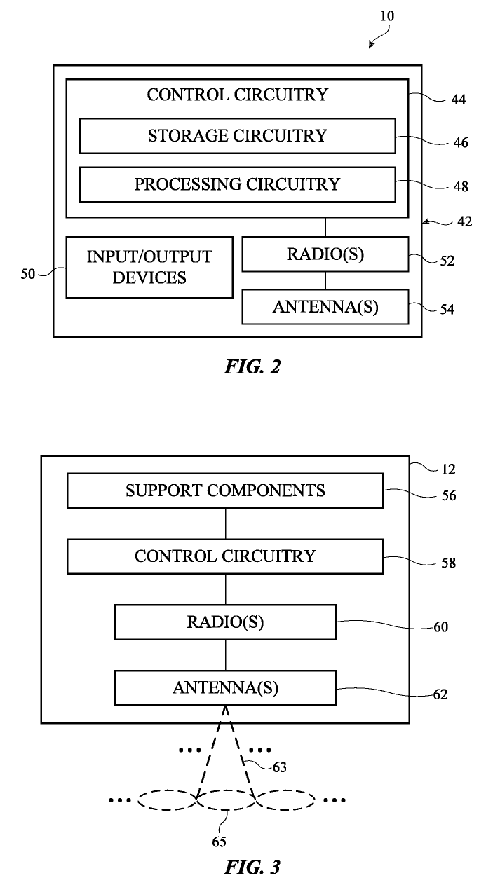

As shown in FIG. 2, UE device 10 may include components located on or within an electronic device housing such as housing 42. Housing 42, which may sometimes be referred to as a case, may be formed of plastic, glass, ceramics, fiber composites, metal (e.g., stainless steel, aluminum, metal alloys, etc.), other suitable materials, or a combination of these materials. In some situations, parts or all of housing 42 may be formed from dielectric or other low-conductivity material (e.g., glass, ceramic, plastic, sapphire, etc.). In other situations, housing 42 or at least some of the structures that make up housing 42 may be formed from metal elements.

UE device 10 may include control circuitry 44. Control circuitry 44 may include storage such as storage circuitry 46. Storage circuitry 46 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 46 may include storage that is integrated within UE device 10 and/or removable storage media.

Control circuitry 44 may include processing circuitry such as processing circuitry 48. Processing circuitry 48 may be used to control the operation of UE device 10. Processing circuitry 48 may include on one or more processors (e.g., microprocessors, microcontrollers, digital signal processors, host processors, baseband processor integrated circuits, application specific integrated circuits, central processing units (CPUs), graphics processing units (GPUs), etc.). Control circuitry 44 may be configured to perform operations in device 10 using hardware (e.g., dedicated hardware or circuitry), firmware, and/or software. Software code for performing operations on UE device 10 may be stored on storage circuitry 46 (e.g., storage circuitry 46 may include non-transitory (tangible) computer readable storage media that stores the software code). The software code is sometimes also referred to as program instructions, software, data, instructions, or code. Software code stored on storage circuitry 46 may be executed by processing circuitry 48.

Control circuitry 44 may be used to run software on UE device 10 such as satellite navigation applications, internet browsing applications, voice-over-internet-protocol (VOIP) telephone call applications, email applications, media playback applications, operating system functions, etc. To support interactions with external equipment, control circuitry 44 may be used in implementing communications protocols. Communications protocols that may be implemented using control circuitry 44 include internet protocols, wireless local area network (WLAN) protocols (e.g., IEEE 802.11 protocols – sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols (e.g., radio detection and ranging (RADAR) protocols or other desired range detection protocols for signals conveyed at millimeter and centimeter wave frequencies), satellite communications protocols, and/or any other desired communications protocols. Each communications protocol may be associated with a corresponding radio access technology (RAT) that specifies the physical connection methodology used in implementing the protocol.

UE device 10 may store satellite information associated with one or more of the satellites 12 in satellite constellation 32 on storage circuitry 46. The satellite information, sometimes referred to herein as ephemeris data or ephemeris information, may include a satellite almanac identifying the orbital parameters/position (e.g., orbit information, elevation information, altitude information, inclination information, eccentricity information, orbital period information, trajectory information, right ascension information, declination information, ground track information, etc.) and/or the velocity of satellites 12 (e.g., relative to the surface of Earth). This information may include a two-line element (TLE), for example. The TLE may identify or include information about the orbital motion of one or more of the satellites 12 in satellite constellation 32 (e.g., satellite epoch, first and/or second derivatives of motion, drag terms, etc.). The TLE may be in the format of a text file having two lines or columns that include the set of elements forming the TLE, for example. Control circuitry 44 may use the ephemeris data to calculate, predict, or identify the location of satellites 12 at a given point in time.

UE device 10 may also include wireless circuitry to support wireless communications. The wireless circuitry may include one or more antennas 54 and one or more radios 52. Each radio 52 may include circuitry that operates on signals at baseband frequencies (e.g., baseband processing circuitry, one or more baseband processors, etc.), signal generator circuitry, modulation/demodulation circuitry (e.g., one or more modems), radio-frequency transceiver circuitry (e.g., radio-frequency transmitter circuitry, radio-frequency receiver circuitry, mixer circuitry for downconverting radio-frequency signals to baseband frequencies or intermediate frequencies between radio and baseband frequencies and/or for upconverting signals at baseband or intermediate frequencies to radio-frequencies, etc.), amplifier circuitry (e.g., one or more power amplifiers and/or one or more low-noise amplifiers (LNAs)), analog-to-digital converter (ADC) circuitry, digital-to-analog converter (DAC) circuitry, control paths, power supply paths, signal paths (e.g., radio-frequency transmission lines, intermediate frequency transmission lines, baseband signal lines, etc.), switching circuitry, filter circuitry, and/or any other circuitry for transmitting and/or receiving radio-frequency signals using antenna(s) 54. The components of each radio 52 may be mounted onto a respective substrate or integrated into a respective integrated circuit, chip, package, or system-on-chip (SOC). If desired, the components of multiple radios 52 may share a single substrate, integrated circuit, chip, package, or SOC.

Antenna(s) 54 may be formed using any desired antenna structures. For example, antenna(s) 54 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. If desired, one or more antennas 54 may include antenna resonating elements formed from conductive portions of housing 42 (e.g., peripheral conductive housing structures extending around a periphery of a display on UE device 10). Filter circuitry, switching circuitry, impedance matching circuitry, and/or other antenna tuning components may be adjusted to adjust the frequency response and wireless performance of antenna(s) 54 over time. If desired, multiple antennas 54 may be implemented as a phased array antenna (e.g., where each antenna forms a radiator or antenna element of the phased array antenna, which is sometimes also referred to as a phased antenna array). In these scenarios, the phased array antenna may convey radio-frequency signals within a signal beam. The phases and/or magnitudes of each radiator in the phased array antenna may be adjusted so the radio-frequency signals for each radiator constructively and destructively interfere to steer or orient the signal beam in a particular pointing direction (e.g., a direction of peak signal gain). The signal beam may be adjusted or steered over time.

Transceiver circuitry in radios 52 may convey radio-frequency signals using one or more antennas 54 (e.g., antenna(s) 54 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antenna(s) 54 may transmit the radio-frequency signals by radiating the radio-frequency signals into free space (or to free space through intervening device structures such as a dielectric cover layer). Antenna(s) 54 may additionally or alternatively receive the radio-frequency signals from free space (e.g., through intervening devices structures such as a dielectric cover layer). The transmission and reception of radio-frequency signals by antenna(s) 54 each involve the excitation or resonance of antenna currents on an antenna resonating element in the antenna by the radio-frequency signals within the frequency band(s) of operation of the antenna.

Each radio 52 may be coupled to one or more antennas 54 over one or more radio-frequency transmission lines. The radio-frequency transmission lines may include coaxial cables, microstrip transmission lines, stripline transmission lines, edge-coupled microstrip transmission lines, edge-coupled stripline transmission lines, transmission lines formed from combinations of transmission lines of these types, etc. The radio-frequency transmission lines may be integrated into rigid and/or flexible printed circuit boards if desired. One or more of the radio-frequency lines may be shared between radios 52 if desired. Radio-frequency front end (RFFE) modules may be interposed on one or more of the radio-frequency transmission lines. The radio-frequency front end modules may include substrates, integrated circuits, chips, or packages that are separate from radios 52 and may include filter circuitry, switching circuitry, amplifier circuitry, impedance matching circuitry, radio-frequency coupler circuitry, and/or any other desired radio-frequency circuitry for operating on the radio-frequency signals conveyed over the radio-frequency transmission lines.

Radios 52 may use antenna(s) 54 to transmit and/or receive radio-frequency signals within different frequency bands at radio frequencies (sometimes referred to herein as communications bands or simply as a “bands”). The frequency bands handled by radios 52 may include satellite communications bands (e.g., the C band, S band, L band, X band, W band, V band, K band, Kₐ band, Kᵤ band, etc.), wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands such as sub-THz bands between around 100 GHz and around 10 THz, etc.), other centimeter or millimeter wave frequency bands between 10-300 GHz, near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest. If desired, radio(s) 52 may generate wireless performance metric data from reverse link signals transmitted by UE device 10 and/or from forward link signals received by UE device 10 CN 20.

Although control circuitry 44 is shown separately from radios 52 in the example of FIG. 2 for the sake of clarity, radios 52 may include processing circuitry that forms a part of processing circuitry 48 and/or storage circuitry that forms a part of storage circuitry 46 of control circuitry 44 (e.g., portions of control circuitry 44 may be implemented on radios 52). As an example, control circuitry 44 may include baseband circuitry or other control components that form a part of radios 52. The baseband circuitry may, for example, access a communication protocol stack on control circuitry 44 (e.g., storage circuitry 46) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

UE device 10 may include input-output devices 50. Input-output devices 50 may be used to allow data to be supplied to UE device 10 and to allow data to be provided from UE device 10 to external devices. Input-output devices 50 may include user interface devices, data port devices, and other input-output components. For example, input-output devices 50 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, orientation sensors, inertial measurement units, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to device 10 using wired or wireless connections (e.g., some of input-output devices 50 may be peripherals that are coupled to a main processing unit or other portion of device 10 via a wired or wireless link). UE device 10 may be owned and/or operated by an end user.

A gateway 14 (FIG. 1) may include one or more radios that include one or more components similar to radio(s) 52, one or more antennas, one or more input/output devices, and control circuitry that includes one or more components similar to control circuitry 44. Unlike UE devices 10, which are generally mobile and able to move between different locations, gateway 14 is stationary and remains at a fixed location on Earth. Gateways 14 are not owned or operated by end users of UE devices 10. Gateway 14 may include one or more electronic devices such as one or more servers or terminals. The electronic device(s) of a gateway 14 may be enclosed within a housing, enclosure, building, etc.

FIG. 3 is a diagram of an illustrative satellite 12 in communications system 38. As shown in FIG. 3, satellite 12 may include satellite support components 56. Support components 56 may include batteries, solar panels, sensors (e.g., accelerometers, gyroscopes, temperature sensors, light sensors, etc.), guidance systems, propulsion systems, and/or any other desired components associated with supporting satellite 12 in orbit above Earth.

Satellite 12 may include control circuitry 58. Control circuitry 58 may be used in controlling the operations of satellite 12. Control circuitry 58 may include processing circuitry such as processing circuitry 48 of FIG. 2 and may include storage circuitry such as storage circuitry 46 of FIG. 2. Control circuitry 58 may also control support components 56 to adjust the trajectory or position of satellite 12 in space.

Satellite 12 may include antennas 62 and one or more radios 60. Radios 60 may use antennas 62 to transmit DL signals 26 and DL signals 30 and to receive UL signals 24 and UL signals 28 of FIG. 1 (e.g., in one or more satellite communications bands). Radios 60 may include transceivers, modems, integrated circuit chips, application specific integrated circuits, filters, switches, up-converter circuitry, down-converter circuitry, analog-to-digital converter circuitry, digital-to-analog converter circuitry, amplifier circuitry (e.g., multiport amplifiers), beam steering circuitry, etc.

Antennas 62 may include any desired antenna structures (e.g., patch antenna structures, dipole antenna structures, monopole antenna structures, waveguide antenna structures, Yagi antenna structures, inverted-F antenna structures, cavity-backed antenna structures, combinations of these, etc.). In some implementations, antennas 62 may include one or more phased array antennas. Each phased array antenna may include beam forming circuitry having a phase and magnitude controller coupled to each antenna element in the phased array antenna. The phase and magnitude controllers may provide a desired phase and magnitude to the radio-frequency signals conveyed over the corresponding antenna element. The phases and magnitudes of each antenna element may be adjusted so that the radio-frequency signals conveyed by each of the antenna elements constructively and destructively interfere to produce a radio-frequency signal beam 63 in a desired pointing direction (e.g., an angular direction towards Earth at which the radio-frequency signal beam exhibits peak gain). Radio-frequency lenses may also be used to help guide the radio-frequency signal beam in a desired pointing direction. Each radio-frequency signal beam also exhibits a corresponding beam width. This allows each radio-frequency signal beam to cover a corresponding area on Earth (e.g., a region on Earth overlapping the radio-frequency signal beam such that the radio-frequency signal beam exhibits a power greater than a minimum threshold value within that region/cell). Satellite 12 may convey radio-frequency signals over multiple concurrently-active signal beams 63 if desired. If desired, satellite 12 may offload some or all of its beam forming operations to gateway 14. Signal beams 63 may sometimes be referred to herein simply as beams 63.

A phased array antenna in satellite 12 may have a set of formable signal beams 63 each oriented in a different beam pointing direction or angle (e.g., a direction or angle of peak signal gain). Each signal beam 63 may be formed using a different respective set of phase and magnitude settings for the antenna elements in the phased array antenna and/or using a different respective set of active antenna elements in the phased array antenna. Satellite 12 may transmit and/or receive radio-frequency signals within the active signal beam(s) 63 of the phased array antenna (e.g., satellite 12 may wirelessly serve UE devices 10 that overlap active signal beam(s) 63). Inactive signal beam(s) 63 do not convey radio-frequency signals. Active signal beams 63 are sometimes also referred to as illuminated, enabled, powered, or energized signal beams 63. Inactive signal beams 63 are sometimes also referred to as unilluminated, disabled, unpowered, or de-energized signal beams 63.

If desired, satellite 12 may switch between different active signal beams 63 over time according to a beam hopping scheme or schedule. The beam hopping scheme may identify a time schedule for the activation of different signal beams 63 for each communications cycle of satellite 12 (e.g., such that each signal beam is active at least once during each cycle). If desired, gateway(s) 14 and/or core network 22 (FIG. 1) may set/specify and/or update the beam hopping schedule for satellite 12. If desired, different satellites may have different beam hopping schedules. If desired, multiple signal beams 63 may be active at the same time in the beam hopping scheme (e.g., where the transmit power of satellite 12 is divided between the active signal beams 63).

Each signal beam 63 of the phased array antenna may overlap a different respective area 65 on Earth. Areas 65 are sometimes also referred to herein as spot beams 65 or cells 65 of satellite 12 or the phased array antenna of satellite 12. Each spot beam 65 represents the projection, onto Earth’s surface, of a different respective signal beam 63 of the phased array antenna. The geographic locations on Earth that are overlapped by spot beams 65 change over time as satellite 12 moves in its orbit around Earth. If desired, each spot beam 65 formable by satellite 12 may at least partially overlap at least one other spot beam 65 formable by that satellite 12 to minimize coverage gaps. All of the active and inactive spot beams 65 of the phased array antenna may represent the overall coverage area of the phased array antenna and satellite 12 at a given time.

If desired, radios 60 and antenna(s) 62 may support communications using multiple polarizations. For example, radios 60 and antenna(s) 62 may transmit and receive radio-frequency signals with a first polarization (e.g., a left-hand circular polarization (LHCP)) and may transmit and receive radio-frequency signals with a second polarization (e.g., a right-hand circular polarization (RHCP)). If desired, the set of signal beams 63 formable by satellite 12 may include a first subset of signal beams that convey LHCP signals (e.g., LHCP signal beams) and a second subset of signal beams that convey RHCP signals (e.g., RHCP signal beams). The LHCP and RHCP signal beams may, for example, be produced using respective multiport power amplifiers (MPAs) on satellite 12. This is illustrative and, in general, satellite 12 may produce any desired number of signal beams 63 having any desired polarizations.

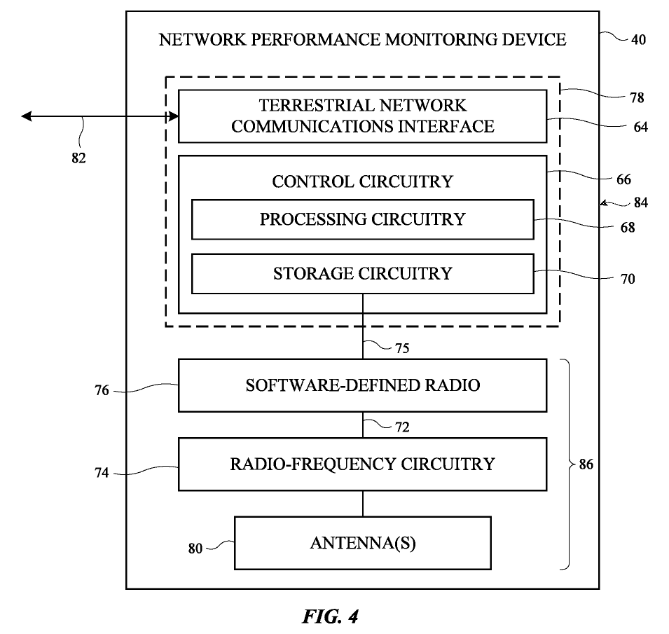

FIG. 4 is a diagram of an illustrative network performance monitoring device 40 in communications system 38. Network performance monitoring device 40 is sometimes also referred to herein as network performance monitor 40, network performance monitoring equipment 40, monitor 40, performance monitor 40, network monitor 40, network device 40, electronic device 40, network diagnostic device 40, network monitoring device 40, SLA compliance monitoring device 40, monitoring device 40, or simply as device 40. Monitoring device 40 may include one or more electronic devices that are used in monitoring, tracking, assessing, identifying, and/or analyzing the performance (e.g., wireless or radio-frequency performance) of communications system 38 in conveying wireless data between UE device(s) 10 and gateway(s) 14 via satellite constellation 32.

As shown in FIG. 4, monitoring device 40 may be enclosed within a housing (enclosure) 84. Housing 84, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 84 may be formed from dielectric or other low-conductivity material (e.g., glass, ceramic, plastic, sapphire, etc.). In other situations, housing 84 or at least some of the structures that make up housing 84 may be formed from metal elements.

Monitoring device 40 may include control circuitry such as control circuitry 66. Control circuitry 66 may include storage such as storage circuitry 70. Storage circuitry 70 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 70 may include storage that is integrated within monitoring device 40 and/or removable storage media.

Control circuitry 66 may include processing circuitry such as processing circuitry 68. Processing circuitry 68 may be used to control the operation of monitoring device 40. Processing circuitry 68 may include one or more processors (e.g., microprocessors, microcontrollers, digital signal processors, host processors, baseband processor integrated circuits, application specific integrated circuits, central processing units (CPUs), graphics processing units (GPUs), etc.). Control circuitry 66 may be configured to perform operations in monitoring device 40 using hardware (e.g., dedicated hardware or circuitry), firmware, and/or software. Software code for performing operations on monitoring device 40 may be stored on storage circuitry 70 (e.g., storage circuitry 70 may include non-transitory (tangible) computer readable storage media that stores the software code). The software code may sometimes be referred to as program instructions, software, data, instructions, or code. Software code stored on storage circuitry 70 may be executed by processing circuitry 68.

Monitoring device 40 may include one or more communications interfaces such as terrestrial network communications interface 64. Terrestrial network communications interface 64 may allow monitoring device 40 to communicate with terrestrial network 34 (FIG. 1) via one or more communications links 82 (e.g., terrestrial communications link to network portion 18 of FIG. 1). Communications links 82 may include wired link and/or wireless links. Terrestrial network communications interface 64 may include one or more radios, one or more antennas, one or more data ports (e.g., Ethernet ports), cabling (e.g., coaxial cabling, Ethernet cabling, etc.) and/or any other desired equipment for communicating with terrestrial network 34 (e.g., without passing information through satellite constellation 32). If desired, terrestrial network communications interface 64 and/or control circuitry 66 may be integrated into a single device 78 within monitoring device 40. Device 78 may be a standalone device such as a desktop computer, laptop computer, cellular telephone, server, or other portable electronic device. Device 78 may be enclosed within a housing that is disposed within housing 84 if desired.

Monitoring device 40 may also include a space network communications interface 86 for communicating with gateway(s) 14 via satellite constellation 32. Space network communications interface 86 may include one or more radios. The radios may, if desired, include a software-defined radio such as software-defined radio (SDR) 76. SDR 76 may be implemented within device 78 or external to device 78 (as shown in the example of FIG. 4). SDR 76 may be coupled to control circuitry 66 over control path 75. Control path 75 may convey control signals and/or data between control circuitry 66 and SDR 76. SDR 76 is a radio that performs one or more functions of a hardware radio (e.g., mixing functions, amplification functions, modulation functions, demodulation functions, detection functions, synthesizer functions, filtering functions, etc.) using software (e.g., as executed by one or more processors such as processing circuitry 68 or other processing circuitry within SDR 76). SDR 76 may, for example, function similar to a modem that allows a computing device (e.g., device 78) to create radio-frequency energy to absorb/decode received radio-frequency energy via antenna(s) 80.

Space network communications interface 86 may also include radio-frequency hardware components such as radio-frequency circuitry 74 and one or more antennas 80. SDR 76 may be coupled to antenna(s) 80 over one or more radio-frequency transmission line path 72. Radio-frequency circuitry 74 may be disposed on radio-frequency transmission line path(s) 72 between SDR 76 and antenna(s) 80. SDR 76 may include one or more analog-to-digital converter (ADC) and/or one or more digital-to-analog converter (DAC) coupled to radio-frequency transmission line path(s) 72. Antenna(s) 80 may include any desired antennas (e.g., antennas such as antennas 54 of FIG. 2 or antennas 62 of FIG. 3). Two or more antennas 80 may be antenna elements of one or more phased array antennas if desired.

Control circuitry 66 may transmit control signals to SDR 76 that control/adjust one or more of the operations of SDR 76. The control signals may control SDR 76 to generate radio-frequency signals and to transmit the radio-frequency signals over radio-frequency transmission line path(s) 72, radio-frequency circuitry 74, and antenna(s) 80. The control signals may control SDR 76 to generate wireless data such as reverse link data that is conveyed using the radio-frequency signals (e.g., that is modulated onto the radio-frequency signals). Antenna(s) 80 may transmit the radio-frequency signals to satellite constellation 32 in IEEE bands such as the IEEE C band (4-8 GHz), S band (2-4 GHz), L band (1-2 GHz), X band (8-12 GHz), W band (75-110 GHz), V band (40-75 GHz), K band (18-27 GHz), Kₐ band (26.5-40 GHz), Kᵤ band (12-18 GHz), and/or any other desired satellite communications bands (e.g., as reverse link signals or uplink signals 24 as shown in FIG. 1). Control circuitry 66 may also transmit the transmitted reverse link data and/or information about the transmitted reverse link data to CN 20 via terrestrial network communications interface 64 and communication link(s) 82.

The wireless data may include reverse link data such as one or more reverse link data packets. The reverse link data may convey messages to CN 20 via satellite constellation 32 and gateway(s) 14. The reverse link data may include a unique identifier associated with monitoring device 40. The unique identifier may identify that the reverse link data was transmitted by a network performance monitoring device rather than a UE device 10. If desired, the reverse link data may be encoded or encrypted based on (using) the unique identifier. CN 20 may have knowledge of the unique identifier (or a decryption key associated with the unique identifier). This may allow CN 20 to identify that the reverse link data was transmitted by a network performance monitoring device rather than a UE device 10 and to decrypt the reverse link data. At the same time, this may shield other network nodes from decrypting the reverse link data or detecting that the reverse link data was transmitted by a network performance monitoring device (e.g., the reverse link data may be indistinguishable from reverse link data transmitted by a UE device 10 and/or may be unencryptable to network nodes other than (outside of) CN 20). The reverse link data may be transmitted by monitoring device 40 to allow CN 20 to monitor the network performance of satellite constellation 32 and/or gateway(s) 14.

Antenna(s) 80 may also receive forward link signals (e.g., DL signals 26 of FIG. 1) from satellite constellation 32. Antenna(s) 80 may pass the received forward link signals to SDR 76 via radio-frequency transmission line(s) 72 and radio-frequency circuitry 74. SDR 76 may demodulate the received signals to obtain (receive) wireless data from the received radio-frequency signals. The received wireless data may include forward link data. SDR 76 may pass the forward link data to control circuitry 66 for subsequent processing. If desired, SDR 76 and/or radio-frequency circuitry 74 may generate wireless performance metric data associated with the transmission of reverse link signals by monitoring device 40 and/or the receipt of forward link signals by monitoring device 40. Control circuitry 66 may transmit signal measurements (e.g., received forward link data, information about received forward link data such as wireless performance metric data, transmitted reverse link data, information about transmitted reverse link data such as wireless performance metric data, etc.) to CN 20 via terrestrial network communications interface 64 and communication link(s) 82. CN 20 may process the signal measurements to monitor the network performance of satellite constellation 32 and/or gateway(s) 14.

Multiple monitoring devices 40 may be distributed across different locations or regions on Earth (e.g., regions that are provided with satellite communications capacity and coverage by the satellites 12 in satellite constellation 32). These regions may be regions where UE devices 10 are expected to be present. This may allow monitoring devices 40 to transmit reverse link data and/or to receive forward link data similar to as would be handled by UE devices 10 in communicating with gateway(s) 14 via satellite constellation 32. Whereas UE devices 10 may transmit full-stack wireless data to, and may receive wireless data from, end hosts of terrestrial network 34 via satellite constellation 32 and gateway(s) 14 (e.g., email data, internet browser data, streaming video data, streaming music data, messaging data, gaming data, cloud computing data, distributed processing data, etc.), monitoring devices 40 may, for example, transmit simplified data to and/or may receive data from gateway(s) 14 via satellite constellation 32 solely for the purpose of allowing CN 20 to monitor the network performance of gateway(s) 14 and/or satellite constellation 32. The network performance monitoring functions may be transparent to satellite constellation 32, gateway(s) 14, NOC 16, and any other network nodes not associated with or a part of CN 20 (e.g., the data conveyed by monitoring devices 40 via satellite constellation 32 may be indistinguishable to satellite constellation 32, gateway(s) 14, NOC 16, and any other network nodes not associated with or a part of CN 20 from data conveyed by UE devices 10).

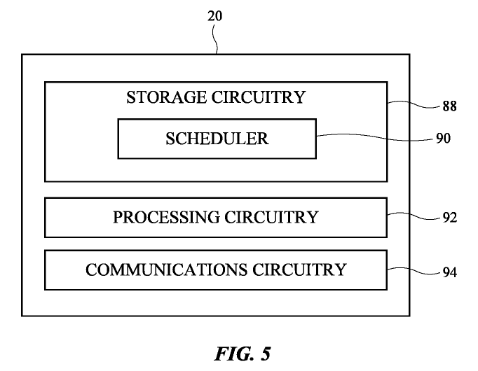

FIG. 5 is a schematic diagram of CN 20. The components of CN 20 may be implemented on one or more underlying physical devices in network portion 18 (FIG. 1). As shown in FIG. 5, CN 20 may include storage circuitry 88 (e.g., similar to storage circuitry 46 of FIG. 2) and processing circuitry 92 (e.g., similar to processing circuitry 48 of FIG. 2). CN 20 may also include one or more communications interfaces such as communications interface 94. Communications interface 94 may include a wired communications interface (e.g., a cabled interface, an optical interface, etc.) and/or a wireless communications interface (e.g., wireless communications circuitry having one or more antennas).

Storage circuitry 88 may store a communications scheduler such as scheduler 90 (e.g., a software-based scheduler that is executed using processing circuitry 92). Scheduler 90 may store communications schedules (e.g., forward link communications schedules) for each of the UE devices 10 that communicate with CN 20 (e.g., that communicate with CN 20 via constellation 32 of FIG. 1 while the UE devices are off grid and/or via terrestrial-based communications equipment 22 while the UE devices are on grid). Scheduler 90 may, for example, generate forward link traffic grants for the UE devices based on and/or implementing the stored communications schedules.

Communications interface 94 may transmit forward link data (e.g., as received from another UE device, a CDN, or another data source, terminal, or end host in communications system 38) to UE devices 10 via constellation 32 and gateway(s) 14 (FIG. 1). If desired, communications interface 94 may transmit forward link traffic grants to gateway(s) 14. Communications interface 94 may also receive reverse link data from UE devices 10 via constellation 94. Communications interface 94 may forward the reverse link data to a corresponding destination (e.g., another UE device, data destination, terminal, or end host in communications system 38).

In addition, communications interface 94 may receive signal measurements performed by monitoring device 40, gateway(s) 14, and/or UE device(s) 10 (e.g., via the terrestrial network and/or the NTN) for use in network performance monitoring. Storage circuitry 64 may store the signal measurements (e.g. in one or more databases or other data structures) for subsequent processing. Storage circuitry 64 may also store software that, when executed by processing circuitry 92, monitors the performance of gateway(s) 14 and satellite constellation 32 based on the stored signal measurements.

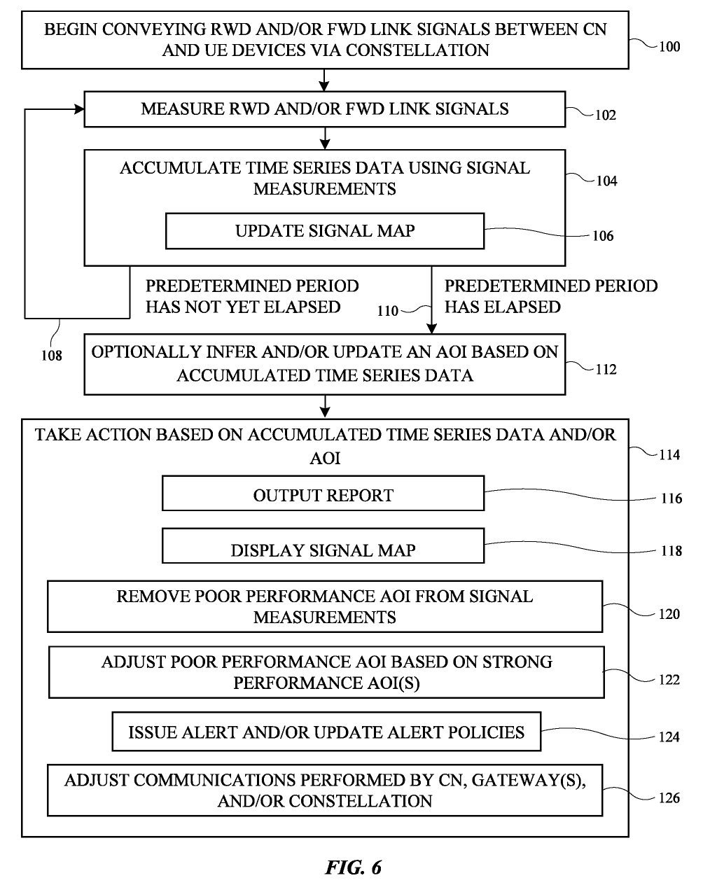

In some implementations, signal measurements are performed in the field and transmitted to CN 20 at a single point in time to serve as a single snapshot of the network performance of constellation 32 and gateway(s) 14 within a geographic region at that single point in time. This type of static performance monitoring may, for example, indicate whether the communications system exhibits satisfactory or unsatisfactory performance within the geographic region at that single point in time but otherwise provides limited insight on the dynamic performance of the communications system. To provide an improved overall analysis of network performance, CN 20 may perform network performance monitoring using a time series overlay of signal measurements performed in the field. FIG. 6 is a flow chart of illustrative operations involved in monitoring the network performance of communications system 48 using time series overlays of signal measurements.

At operation 100, communications system 38 may begin conveying reverse link and/or forward link signals (data) between UE device(s) 10 and CN 20 via constellation 32. Communications system 38 may continue to convey reverse link and/or forward link signals between UE device(s) 10 and CN 20 via constellation 32 before, after, and/or concurrent with one or more of the remaining operations of FIG. 6.

At operation 102, one or more nodes of communications system 38 may generate (e.g., perform, measure, output, compute, identify, produce, capture, etc.) signal measurements from the reverse link signals and/or the forward link signals conveyed between UE device(s) 10 and CN 20 via constellation 32. The one or more nodes that perform the signal measurements may include one or more monitoring devices 40, one or more gateways 14, one or more UE devices 10, other radio-frequency transmitter, receiver, and/or measurement equipment in communications system 38, terrestrial radios, internal satellite systems, and/or any other nodes of communications system 38. If desired, the signal measurements may include reverse link measurements generated by UE device(s) 10, monitoring device(s) 40, and/or another transmitting node or transmitting equipment upon transmitting reverse link signals/data. Additionally, or alternatively, the signal measurements may include reverse link measurements generated by gateway(s) 14, CN 20, and/or another receiving node or receiving equipment upon receiving reverse link signals/data transmitted by UE device(s) 10, monitoring device(s) 40, and/or another transmitting node or transmitting equipment. If desired, the signal measurements may include forward link measurements generated by UE device(s) 10, monitoring device(s) 40, and/or another receiving node or receiving equipment upon receiving forward link signals/data transmitted by gateway(s) 14. Additionally, or alternatively, the signal measurements may include forward link measurements generated by gateway(s) 14 upon transmitting forward link signals/data.

The one or more nodes may transmit the signal measurements to CN 20 via terrestrial network 34 and/or NTN 33 (FIG. 1) for storage and subsequent processing. The signal measurements may include wireless performance metric data generated by the one or more nodes. Additionally, or alternatively, the signal measurements may include some or all of the wireless data (e.g., forward and/or reverse link data) transmitted or received by the one or more nodes.

The signal measurements received by CN 20 may include or may otherwise be associated with corresponding geographic coordinates. The geographic coordinates may represent the geographic location of the one or more nodes that generated the signal measurements, the location of one or more nodes that conveyed signals that were used in performing the signal measurements, and/or the location in space of the satellite(s) 12 serving the one or more nodes and/or conveying the signals that were used in performing the signal measurements. CN 20 may have knowledge of which satellite(s) 12 in constellation 32 served each node that generated the signal measurements and may have knowledge of the location(s) of those satellites during the current sub-period (e.g., from satellite almanac information stored at the CN). The geographic coordinates may, for example, be included in or otherwise identified by the signal measurements transmitted to CN 20. Additionally, or alternatively, CN 20 may determine the geographic coordinates from identification information that identify the one or more nodes and that is transmitted to CN 20 along with the signal measurements (e.g., CN 20 may identify which node(s) transmitted the signal measurements based on the identification information and may determine the geographic coordinates from a known location of the identified node(s)).

At operation 104, CN 20 may accumulate time series data using the signal measurements received from the one or more nodes (e.g., in storage circuitry 88 of FIG. 5). The time series data may include signal measurements from a current sub-period (portion) of a predetermined time period as well as signal measurements from one or more previous sub-periods (portions) of the same predetermined time period. CN 20 may accumulate the time series data by adding, combining, averaging, compiling, overlapping, and/or otherwise accumulating the signal measurements, generated by the one or more nodes and/or received by CN 20 during the current sub-period of the predetermined time period, with previously received signal measurements generated by the same one or more nodes and/or received by CN 20 during one or more prior sub-periods. The predetermined time period may be on the order of several minutes, hours, days, or weeks, as examples. The sub-period may be, for example, the duration of one or more system cycles of communications system 38.

If desired, the accumulated time series data (e.g., measured wireless performance metric data) may include difference values. The difference values may represent or correspond to a difference between wireless performance metric data that the CN expects and/or predicts to be measured by the one or more nodes and the wireless performance metric data that is actually measured by the one or more nodes during signal reception and/or transmission. The CN may generate, calculate, compute, produce, output, and/or otherwise identify the expected/predicted wireless performance metric data based on one or more physical/mathematical models of how signals and data are conveyed between the CN and UE devices in a geographic region via the constellation and gateway(s). The model(s) may, for example, account for the physical geometry and characteristics of components in the path of the forward and reverse links (e.g., free space path loss, hardware noise, cabling noise, etc.) and may be determined by combining TLE data, satellite characteristics, etc. The expected/predicted wireless performance metric data may be stored in a predicted/expected data set sometimes also referred to herein as a predetermined time series data of interest (TSDOI). The CN may generate the predetermined TSDOI in advance and/or may update the predetermined TSDOI over time. The CN may store the predetermined TSDOI for comparison to corresponding measured/accumulated time series data of interest in the received signal measurements. The received and accumulated signal measurements may also be stored in an intermediate data set sometimes also referred to herein as a measured/accumulated time series data of interest (TSDOI), which may correspond to the same geographic region as the predetermined TSDOI. CN 20 may generate (e.g., calculate, compute, identify, detect, measure, etc.) the difference values by computing the difference between the measured/accumulated TSDOI (e.g., wireless performance metric data from the signal measurements received from the one or more nodes) and the predetermined TSDOI (e.g., as computed based on the one or more models).

CN 20 may store the received signal measurements along with the corresponding geographic coordinates and time information identifying the current sub-period (e.g., in a database with previously received signal measurements). This information may collectively form a snapshot of network performance in one or more geographic areas (e.g., as identified by the geographic coordinates) during the current sub-period. By accumulating or combining the signal measurements (e.g., wireless performance metric data and/or difference values in the received signal measurements) received from nodes in a given geographic area during the current sub-period with signal measurements (e.g., wireless performance metric data and/or difference values in the received signal measurements) received from nodes in the same geographic area during one or more previous sub-periods, CN 20 may generate a time-series of snapshots of network performance in the geographic area. The time-series of snapshots may provide the core network with dynamic insights into how network performance has changed over time in the geographic area and/or may help the core network to identify aspects of wireless performance in and/or around the geographic area that would not otherwise be detectable from a single snapshot of signal measurements from the geographic area during a single sub-period. For example, the time-series of snapshots may reveal an area of interest (AOI) overlapping the geographic area that would not otherwise be detectable from signal measurements of a single sub-period and that may serve as a target for subsequent network monitoring operations and/or adjustments. The AOI may correspond to, may include, and/or may be identified by the measured/accumulated TSDOI and/or difference values computed using the measured/accumulated TSDOI and the predetermined/expected TSDOI for the same geographic coordinates.

If desired, at optional operation 106, CN 20 may generate and store data that is representable by a signal map in storage circuitry. This data may include the measured/accumulated TSDOI, the predetermined TSDOI, and/or difference values between the measured/accumulated TSDOI and the predetermined TRSDOI. This procedure is sometimes also referred to herein as generating the signal map. When displayed by a display device, the signal map may form a visual representation of the accumulated signal measurements across different geographic locations on Earth. CN 20 may store the data representable by a signal map as data in a data structure (e.g., a database of measured/accumulated TSDOI and predetermined TSDOI in storage circuitry) for later display by the display device. Any operations/updates described herein that CN 20 performs on the signal map may, in practice, be performed by CN 20 on the corresponding data that is representable by the signal map, as stored in the data structure (e.g., operations described herein as being performed by CN 20 on the signal map may correspond to mathematical, programmatic, software, and/or processing operations performed by CN 20 on stored data that is otherwise representable by the signal map, but are sometimes described herein based on their visual effect on the signal map after display of the signal map by a display device for the sake of clarity). This stored data (e.g., after operations/updates performed on the stored data by the CN) may be used for any desired purpose, including in a displayed signal map. As an example, the stored data representable by the signal map may include an overlay of single sub-period snapshots of wireless performance metric data in geographic coordinates over the predetermined time period (e.g., geographically mapping signal measurements to the corresponding geographic coordinates associated with the signal measurements). The stored data tharepresentable by the signal map may include data associated with one or more geographical indicators associated with the signal measurements accumulated for different locations across a geographic region. If/when the signal map is displayed by a display device, the geographical indicators may form graphical indicators that change in appearance (e.g., shading, intensity, color, etc.) as more signal measurements are accumulated and overlap at the same locations in the geographic region. Operation 106 may be omitted if desired.

If/when the predetermined time period has not yet elapsed, processing loops back to operation 102 via path 108 as the next sub-period of the predetermined time period begins (e.g., each iteration or loop of operations 102-104 may correspond to or be performed within a single sub-period of the predetermined time period). CN 20 may continue to receive and accumulate signal measurements for subsequent sub-periods of the predetermined time period. This may include, for example, updating the stored data representable by the signal map (at operation 106) based on signal measurements received during each sub-period and the geographic coordinates of the one or more nodes that generated the signal measurements. In this way, when the stored data is displayed as the signal map, the signal map may serve as a visual representation of the time-series data accumulated by the core network across multiple sub-periods (e.g., across the predetermined time period). CN 20 may accumulate time series data and/or may update the data representable by the signal map in this way for all geographic areas served by constellation 32 across Earth. Geographic areas are sometimes also referred to herein as geographic regions and span a set of geographic locations (e.g., a continuous set of geographic locations). Although the stored data may be representable by the signal map, the stored data need not be used to generate a signal map that is displayed by a display device (e.g., the signal map may be derived from the stored measured/accumulated TSDOI, predetermined TSDOI, and/or difference values between the measured/accumulated TSDOI and the predetermined TSDOI).

The predetermined time period may, if desired, be set by CN 20, the satcom network service provider associated with CN 20, an administrator of CN 20, etc. The predetermined time period may be constant or may be dynamically adjusted over time. Once the predetermined time period has elapsed, processing may proceed from operation 104 to operation 112 via path 110. If desired, CN 20 may advance from operation 104 to operation 112 via path 110 prior to the predetermined time period elapsing if/when a suitable trigger condition occurs. The trigger condition may include, for example, a command, input, or instruction received by the CN (e.g., from a user input device communicatively coupled to the CN, an administrator of the CN, software running on the CN, etc.) or the occurrence of any other event that triggers further action based on the accumulated time series data.

At optional operation 112, CN 20 may infer (e.g., generate, interpolate, identify, detect, calculate, compute, estimate, etc.) and/or update a geographic AOI based on the accumulated time series data and/or the generated signal map. In some situations, the AOI may represent an area on Earth where communications system 38 exhibits relatively poor wireless performance (e.g., less than a threshold level of performance). These types of AOIs are sometimes also referred to herein as poor, week, or unsatisfactory performance AOIs. Additionally, or alternatively, the AOI may represent an area on Earth where communications system 38 exhibits relatively strong wireless performance (e.g., greater than the threshold level of performance). These types of AOIs are sometimes also referred to herein as strong, satisfactory, or good performance AOIs.

CN 20 may identify an AOI by, for example, comparing signal measurements that have been accumulated, combined, and/or added for different geographic locations to the threshold level of performance. CN 20 may define geographic locations that have accumulated signal measurements (e.g., wireless performance metric data) that collectively exceed the threshold level for the predetermined time period as strong performance AOIs. As another example, CN 20 may define geographic locations that have more successful communications via constellation 32 than unsuccessful communications via constellation 32 as strong performance AOIs. On the other hand, CN 20 may define geographic locations that have accumulated signal measurements (e.g., wireless performance metric data) that are collectively less than the threshold level for the predetermined time period as poor performance AOIs. As another example, CN 20 may define geographic locations that have fewer successful communications via constellation 32 than unsuccessful communications via constellation 32 as poor performance AOIs. If desired, CN 20 may generate a geographic indicator for the signal map (e.g., in implementations where operation 106 is performed) that identifies the AOI(s) (e.g., as a graphical indicator on the signal map when the signal map is displayed by a display device). If desired, operation 112 may be omitted.

At operation 114, one or more nodes of communications system 38 (e.g., CN 20, NOC 16, gateway(s) 14, constellation 32, UE devices 10, etc.) may perform one or more actions based on the accumulated time series data (e.g., the measured/accumulated TSDOI, the predetermined TSDOI, and/or difference values) and/or based on the AOI(s) generated or updated at operation 112. This may include performing any desired combination of one or more of operations 116-126. Operations 118-126 may be performed in any order. Some or all of operations 118-126 may be omitted. Two or more of operations 118-126 may be performed concurrently, if desired.

At operation 116, CN 20 may generate a network performance report based on the accumulated time series data and/or AOI(s) and may output the report over a communications link (e.g., via a communications interface of the CN). The network performance report may include the accumulated time series data, information about the accumulated time series data (e.g., information identifying one or more statistics, trends, or insights from the accumulated time series data), the identified AOI(s), information about the identified AOI(s), the generated signal map, and/or any other desired information. CN 20 may output the report and may transmit the report, over the terrestrial network, to one or more network nodes associated with the satcom network service provider, one or more network nodes associated with NOC 16 (FIG. 1), one or more nodes associated with a terrestrial network carrier, one or more end hosts of network portion 18 (FIG. 1), one or more UE devices 10, a network node having an output device such as a display or monitor, and/or any other desired entity of communications system 38. The entity or entities that receive the report may perform any desired action based on the contents of the report (e.g., based on network performance level at different geographic locations as identified by the report). This may include performing one or more of operations 118-126 of FIG. 6, display of one or more portions of the report to a user, administrator, or operator, etc.

As another example, at operation 118, a terminal in communications system 38 may display the signal map generated by CN 20 on a display (e.g., a computer monitor, a touch-sensitive display, etc.). The terminal may be a node that receives the report generated at operation 116, a terminal of CN 20, a terminal associated with the satcom network service provider, a terminal of NOC 16, an end host of network portion 18, a terminal associated with a terrestrial network carrier, a UE device 10, or another device in communications system 38. The displayed signal map may, if desired, include a graphical indicator identifying the AOI(s) of the signal map. If desired, an AOI may be displayed within a graphical user interface having one or more interactive elements that can be interacted with (e.g., via a user input device) to change how the signal map is displayed by the display. The displayed signal map may serve to inform a user of the terminal about the wireless performance of communications system 38 over the predetermined time period across one or more geographic regions (e.g., across the areas of Earth served by satellite constellation 32). This may, for example, allow the user to have knowledge of the dynamic status of the network throughout the predetermined time period, allowing the user to more easily identify and implement/trigger one or more adjustments to the operations of the communications system based on the dynamic status of the network (e.g., in a manner that improves network performance).

As another example, at operation 120, CN 20 may remove, subtract, filter, or mask out some or all of the signal measurements in a poor performance AOI from the accumulated time series data, from the signal map (e.g., as displayed at operation 118), and/or from the report generated by CN 20 (e.g., as output at operation 116) for a corresponding geographic area. This may, for example, prevent signal measurements of the poor performance AOI from skewing, distorting, or otherwise impacting the accuracy and/or reliability of signal measurements in the accumulated time series data outside of the poor performance AOI. Conversely, at operation 122, CN 20 may adjust the geographic boundaries of one or more poor performance AOIs in the accumulated time series data based on one or more strong performance AOIs in the accumulated time series data (e.g., shrinking a poor performance AOI when a portion of the poor performance AOI overlaps a strong performance AOI).

These operations may, for example, allow CN 20 to output a report or map of the coverage areas of constellation 32 having satisfactory levels of wireless performance that is independent of geopolitical boundaries within the signal map (e.g., providing a greater degree of visibility and resolution into network performance than in implementations where signal measurements within a particular geopolitical boundary such as within a corresponding country are combined together to assess network performance). Each AOI may, for example, extend beyond the boundaries of a particular geopolitical jurisdiction, may be confined entirely within a single geopolitical jurisdiction, or may extend across multiple geopolitical jurisdictions. The report and/or signal map generated by CN 20 may identify areas of relatively strong wireless/network performance (e.g., strong performance AOIs) and/or areas of relatively weak wireless/network performance (e.g., poor performance AOIs) that are independent of these geopolitical jurisdictions, providing the satcom network service provider and/or the NOC with a greater degree of flexibility and resolution when assessing and adjusting network performance.

As yet another example, at operation 124, CN 20 may generate and issue an alert based on the accumulated time series data and/or AOI(s). The alert may be transmitted to a user, operator, and/or administrator of CN 20, the satcom network service provider, and/or NOC 16, as examples. The alert may serve to inform the user, operator, and/or administrator of an issue, emergency, problem, failure, or other non-ideality in the wireless service provided by satellite constellation 32 (e.g., to help the user, operator, and/or administrator to act as quickly as possible to adjust the network to mitigate, fix, or resolve the issue, emergency, problem, failure, or other non-ideality).

As examples, the alert may include a text-based message, a graphics-based message, a paging message, a telephone call, and/or an audio-based message. If desired, the alert may be displayed by a display of a terminal of CN 20, the satcom network service provider, and/or NOC 16. If desired, the alert may include one or more graphical indicators (e.g., a warning icon, alarm icon, etc.) displayed on the signal map generated by CN 20. The alert may identify one or more geographic locations or areas that have, during the predetermined time period, less than a threshold level of wireless performance (e.g., one or more poor performing AOIs or locations outside of poor performing AOIs) and/or that are associated with signal measurements that lie within a predetermined range of signal measurements that is set to trigger the issuance of an alert. CN 20 may, if desired, include information associated with wireless performance at these geographic locations (e.g., the accumulated signal measurements or wireless performance metric data for the geographic locations), information identifying network nodes associated with and/or serving these geographic locations, and/or any other desired information about network performance in the service area of constellation 32 with or within the issued alert.

If desired, CN 20 may set, adjust, and/or update one or more alert policies (e.g., policies governing when an alert is issued) based on the accumulated time-series data and/or a detected AOI. As one example, CN 20 may forego or delay transmissions of an alert for a location within a poor performance AOI (e.g., to prevent excessive notifications to the user, operator, and/or administrator who receives the alerts when the alerts are associated with an area that exhibits sufficiently poor performance over a relatively long time period). As another example, CN 20 may apply a different threshold governing when an alert is issued for geographic locations within a poor performance AOI than outside of the poor performance AOI. The threshold may, for example, be harder to meet within the poor performance AOI than outside of the poor performance AOI.

At operation 126, CN 20 may perform one or more adjustments to the communications performed via constellation 32 based on the accumulated time series data and/or AOI(s). This may include, if desired, CN 20 transmitting a signal or message to NOC 16 instructing NOC 16 to perform some or all of the one or more adjustments, transmitting a signal or message to gateway(s) 14 to perform some or all of the one or more adjustments, transmitting a signal or message to satellite(s) 12 to perform some or all of the one or more adjustments, transmitting a signal to UE device(s) 10 to perform some or all of the one or more adjustments, adjusting forward link grants that are transmitted to gateway(s) 14, adjusting the forward link data transmitted by CN 20, adjusting forward link data transmission timing, and/or adjusting one or more communications schedules implemented by scheduler 90 (FIG. 5).

The adjustments may be any desired adjustments that change, tune, or adjust the operation of CN 20, gateway(s) 14, and/or constellation 32 in a manner that improves the performance of constellation 32 in conveying wireless data with UE devices 10 (e.g., by mitigating, compensating for, or correcting performance issues that are identified by the accumulated time series data and/or AOI(s)). As one example, one or more satellites 12 may adjust their beam hopping schedule(s), may adjust the dwell time of one or more signal beams 63 (FIG. 3) (e.g., increasing the amount of time signal beams overlapping a poor performance AOI are active to help improve wireless/network performance for UE devices in the poor performance AOI), may adjust the pointing direction of one or more signal beams 63, may activate one or more signal beams 63, may deactivate one or more signal beams 63, may adjust the transmit power level of one or more signal beams 63 (e.g., boosting transmit power level for signal beams overlapping poor performance AOIs and/or reducing transmit power level for signal beams overlapping strong performance AOIs), may adjust the polarization of one or more signal beams 63, may adjust the frequency of one or more signal beams 63, and/or may adjust any other desired signal transmission characteristics to help mitigate issues identified by the accumulated time series data. As another example, NOC 16 may adjust one or more orbital parameters of one or more satellites 12 based on the accumulated time series data (e.g., adjusting the trajectory or orbit of the satellite(s) to provide more coverage to a poor performance AOI). As another example, CN 20 may schedule less communications traffic or may at least temporarily forego communications with UE devices in a poor performance AOI (e.g., shifting communications resources such as time and power that would otherwise be wasted in a poor performance AOI to UE devices at other locations).

As another example, gateway(s) 14 may adjust their transmit power level for forward link signal transmissions and/or may switch which satellites 12 the gateway(s) use to communicate with UE devices 10 based on the accumulated time series data. The adjustment(s) performed at operation 126 may, for example, be performed based on and/or in response to information that is displayed in the signal map generated by CN 20 (at operation 118), information that is included in the report generated by CN 20 (at operation 116), and/or information that is included in an alert issued by CN 20 (at operation 124). These examples are non-limiting and, in general, any desired nodes of communications system 38 may perform any desired signal and/or data transmission/reception adjustments based on the accumulated time series data and/or the identified AOI(s). Any desired nodes in communications system 38 may perform any desired actions or operations based on, using, and/or in response to some or all of the accumulated time series data and/or the identified AOI(S).

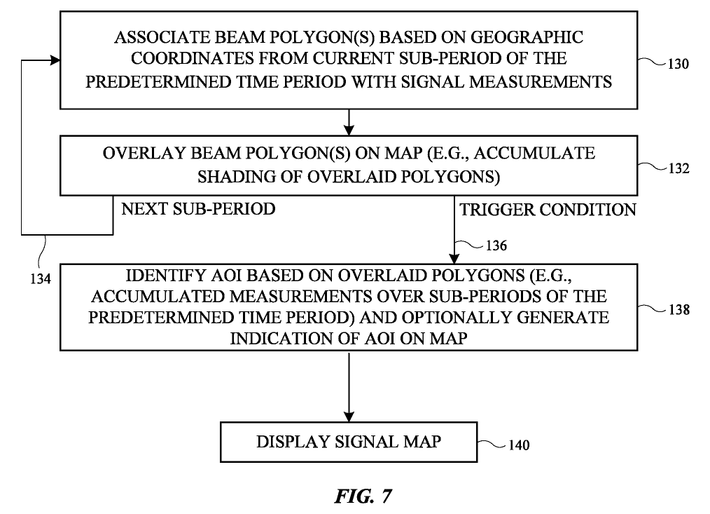

FIG. 7 is a flow chart of illustrative operations that may be performed by CN 20 in generating, updating, and displaying a signal map based on time-series data accumulated while iterating through operation 104 of FIG. 6 (e.g., during each consecutive sub-period of the predetermined time period). Operations 130-138 of FIG. 7 may, for example, be performed while processing operation 104 of FIG. 6. Operation 140 of FIG. 7 may be performed while processing operation 118 of FIG. 6.

At operation 130 of FIG. 7, CN 20 associate (e.g., identify generate, compute, calculate, deduce, infer, interpolate, identify, etc.) one or more beam polygons for the signal map based on geographic coordinates from the current sub-period of the predetermined time period with corresponding received signal measurements. Put differently, CN 20 may identify beam polygon(s) based on received signal measurements and corresponding geographic coordinates for the current sub-period of the predetermined period (e.g., for the current iteration of operation 108 of FIG. 6 or operation 130 of FIG. 7). Each beam polygon may span a respective geographic area of the signal map (e.g., a set of contiguous or continuous geographic locations). The area spanned by each beam polygon may correspond to a respective spot beam 65 (FIG. 3) of a satellite 12 in constellation 32 (e.g., each beam polygon may be a projection of a respective signal beam 63 onto Earth’s surface from a corresponding satellite 12 in space). While referred to herein as polygons, the beam polygons need not be geometric polygons and may, in general, have any shape with any number of straight and/or curved edges.

Each beam polygon may, for example, include, represent, and/or otherwise be associated with signal measurements from geographic locations overlapping that beam polygon on the signal map (e.g., may represent signal measurements performed by one or more UE devices 10, monitoring devices 40, and/or other nodes at geographic locations overlapping that beam polygon and/or signal measurements performed by gateway(s) 14 based on signals transmitted by one or more UE devices 10 and/or monitoring devices 10 at geographic locations overlapping that beam polygon). When the signal map is displayed by a display device, each beam polygon may be provided with one or more graphical properties (e.g., color value, transparency level, shading, etc.) associated with and/or indicative of its corresponding signal measurements (e.g., where different color values, shades, transparency levels, etc., correspond to different signal measurement values or ranges of values). This example is illustrative and non-limiting. This procedure and the operations of FIG. 7 other than operation 140 may be performed mathematically/algorithmically (e.g., by one or more processors) for subsequent operation by devices other than display devices, and any desired characteristics associated with the beam polygons may be stored and used in later processing if desired.

If desired, CN 20 may identify/associate beam polygons for later display on the signal map only when the signal measurements (e.g., wireless performance metric data) of those beam polygons are within a predetermined range of values, exceed a corresponding threshold/limit, or fall below a corresponding threshold/limit. For example, each beam polygon may represent a respective spot beam 65 that produced relatively poor wireless performance metric data (e.g., difference values exceeding a difference value threshold) or that produced relatively strong wireless performance metric data (e.g., difference values less than a difference value threshold). This may serve to minimize clutter in the signal map to more easily identify regions of the signal map that exhibit relatively strong network performance or that exhibit relatively weak network performance (e.g., facilitating the recognizability of correctable network performance issues in the signal map).

At operation 132, CN 20 may overlay the identified beam polygon(s) with the signal map and any beam polygons that are already present on the signal map (e.g., beam polygons that were generated during one or more previous sub-periods or iterations of operation 130). Some beam polygons may, for example, overlap a beam polygon in the signal map that is associated with signal measurements from a previous sub-period (e.g., when those beam polygons correspond to an overlapping geographical area). If desired, a graphical property of one beam polygon may add or combine with a graphical property of an overlapping beam polygon on the signal map when the signal map is displayed by a display device. Put differently, the signal map may include a graphical indication of a sum, average, or other combination of signal measurements from multiple beam polygons within a region of the signal map where those multiple beam polygons overlap. For example, when the signal map is displayed by a display device, a geographic area of the signal map may be depicted with a darker shade (e.g., the shade of different beam polygons may accumulate where the beam polygons overlap), less transparency (more opacity), and/or a different color as the number of beam polygons overlapping that geographic region increase.

As sub-periods of the predetermined time period increment, processing may loop back to operation 130 via path 134 and CN 20 may continue to identify/associate beam polygons for the signal map based on signal measurements that are received from nodes of communications system 38 and the ephemeris of the satellite(s) 12 that conveyed the signals used in the signal measurements. If/when a trigger condition occurs, processing may proceed from operation 132 to operation 138 via path 136. As one example, the trigger condition may be the completion of the predetermined time period (see, e.g., path 110 of FIG. 6). As another example, the trigger condition may be a command, control signal, or input (e.g., from a software application executed by CN 20 and/or received by a user input device of CN 20) instructing CN 20 to stop identifying beam polygons on the signal map.

At operation 138, CN 20 may identify one or more AOIs based on the beam polygons associated with the signal map. As one example, CN 20 may identify an AOI as a geographic region, in the stored data associated with the signal map, where at least N beam polygons are overlapping with each other. N may be any desired integer greater than or equal to two (e.g., three, four, five, ten, sixteen, twenty, 32, 64, 100, 1000, etc.). The AOI may be a poor performance AOI when each of the N beam polygons correspond to wireless performance metric data that is outside of a range of acceptable wireless performance metric data values (e.g., wireless performance metric data that is less than a minimum wireless performance metric data threshold/limit or greater than a maximum wireless performance metric data threshold/limit). The AOI may be a strong performance AOI when each of the N beam polygons correspond to wireless performance metric data that is within the range of acceptable wireless performance metric data values (e.g., wireless performance metric data that exceeds the minimum wireless performance metric data threshold/limit or less than a maximum wireless performance metric data threshold/limit). In other implementations, AOIs of the signal map may be pre-defined by an operator (e.g., the satcom network service provider associated with CN 20) instead of being inferred by CN 20. The AOI need not be defined by overlapping polygons.

This example in which CN 20 identifies an AOI by the number of overlapping beam polygons on the signal map is illustrative and non-limiting. As another example, the signal map may form a heat map of any desired continuous variable (e.g., wireless performance metric) from the signal measurements, where accumulated signal measurements of the continuous variable may be graphically depicted using a continuously variable graphical display element (e.g., color, shading, intensity, brightness, etc.) in the signal map when displayed by a display device. As more signal measurements at a given geographic location are accumulated while iterating through operation 104 of FIG. 6 (e.g., as the sum or combination of signal measurements increase), the eventual graphical depiction of the signal map at that geographic location may change when displayed by a display device. In these implementations, CN 20 may identify a poor performance AOI as a region in the signal map where the accumulated signal measurements (e.g., as added or combined together through each iteration of operation 104 of FIG. 6) are outside of a range of acceptable values (e.g., less than a minimum threshold/limit or greater than a maximum threshold/limit). As yet another example, CN 20 may identify a strong performance AOI as a region in the signal map where the accumulated signal measurements (e.g., as added or combined together through each iteration of operation 104 of FIG. 6) are within a range of acceptable values (e.g., greater than a minimum threshold/limit or less than a maximum threshold/limit). If desired, CN 20 may generate a geographic indicator of the AOI for display on the signal map. The geographic indicator may include text, icons, special shading, a graphical outline of the AOI, etc. The geographic indicator may be represented by one or more graphical elements when the signal map is displayed by a display device.

At operation 140, CN 20 may cause the signal map to be displayed by a terminal or node of CN 20, NOC 16, and/or any other desired device in communications system 38 (e.g., while processing operation 118 of FIG. 6). The example of FIG. 7 is illustrative and non-limiting. Operation 138 need not flow into operation 140. For example, the AOI and the beam polygons as identified at operations 132 and 138 may be fed to any other desired processing circuitry and/or software rather than a display device (e.g., for programmatic evaluation and subsequent action on the signal map, stored data representable by the signal map, the beam polygons, and/or stored data represented by or associated with the beam polygons, such as while processing any of operations 116-126 of FIG. 6).

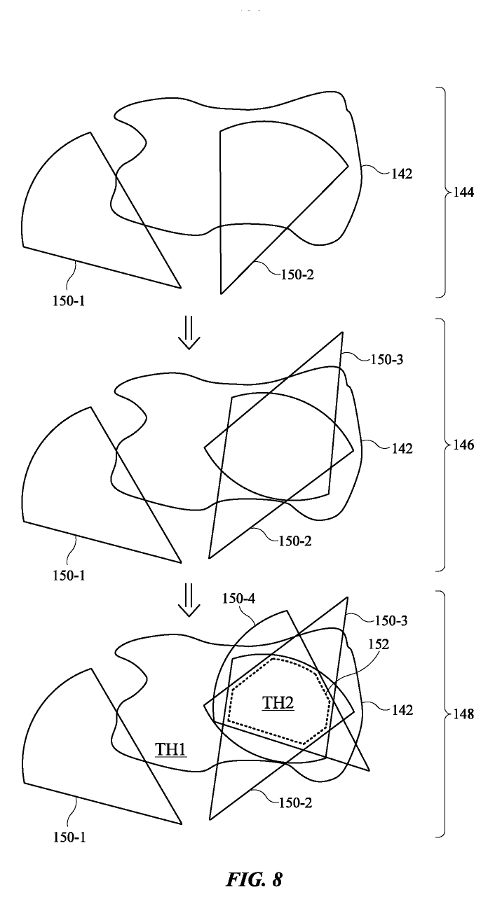

FIG. 8 is a diagram showing one example of how CN 20 may generate a signal map by accumulating and overlaying beam polygons based on received signal measurements. The example of FIG. 8 illustrates a signal map for a geographic region 142 (e.g., when displayed by a display device). The signal map may include one or more graphics or other graphical elements that depict or illustrate geographic region 142 and/or its boundaries. Geographic region 142 may represent a country, city, state, province, continent, island, county, town, municipality, geopolitical jurisdiction, or any other desired geographic area on Earth. If desired, the signal map may extend across multiple geographic regions to include all geographic areas that are served by constellation 32 (e.g., the signal map of FIG. 8 may illustrate only a portion of a subset of the entire signal map generated by CN 20).

Portion 144 of FIG. 8 represents the signal map as generated during a first sub-period of the predetermined time period (e.g., after a first iteration of operation 130 of FIG. 7 and operation 106 of FIG. 6). Portion 146 of FIG. 8 represents the signal map as updated during a second sub-period of the predetermined time period (e.g., after a second iteration of operation 130 of FIG. 7 and operation 106 of FIG. 6). Portion 148 of FIG. 8 represents the signal map as updated during a third sub-period of the predetermined time period (e.g., after a third iteration of operation 130 of FIG. 7 and operation 106 of FIG. 6).

CN 20 may identify a set of one or more beam polygons 150 that are included in stored data representing the signal map and that may be displayed or overlaid on the signal map while displayed by a display device (e.g., CN 20 may project beam polygons 150 onto the signal map). Each beam polygon 150 may represent a respective spot beam 65 (FIG. 3) on Earth (e.g., from a corresponding satellite 12 at a location in space given by its ephemeris). Each beam polygon 150 may be associated with signal measurements that are within a particular range of values. The geographic locations spanned by each spot beam 65 and thus each beam polygon 150 may be determined from the coordinates of the corresponding satellite 12 that produced the spot beam, which are known to the CN as a function of time from the satellite almanac/ephemeris associated with constellation 32 (e.g., each beam polygon 150 may represent the projection of a corresponding signal beam onto the surface of Earth from the position of the corresponding satellite 12 in space). The signal measurements may include signal measurements performed by UE device(s) 10, monitoring device(s) 40, and/or other nodes at locations represented by beam polygon 150 and/or may include signal measurements performed by gateway(s) 14 from signals transmitted by UE device(s) 10, monitoring device(s) 40, and/or other nodes at locations represented by beam polygon 150.

For example, each beam polygon 150 may represent a geographic area where the signal measurements exhibited relatively strong wireless performance (e.g., included wireless performance metric data within a predetermined range of values, less than a maximum threshold/limit, or greater than a minimum threshold/limit). Alternatively, each beam polygon 150 may represent a geographic area where signal measurements exhibited relatively poor wireless performance (e.g., included wireless performance metric data outside the predetermined range of values, greater than the maximum threshold/limit, or less than the minimum threshold/limit). As one example, a beam polygon 150 may represent a geographic area where signal measurements included SNR difference values (e.g., computed as the difference between the measured SNR, from the TSDOI of the wireless performance metric data accumulated for the geographic area over the predetermined period, and the expected SNR from the predetermined TSDOI for the geographic area) that exceed a threshold over the corresponding sub-period.

As shown in portion 144 of FIG. 8, CN 20 may identify a first beam polygon 150-1 and a second beam polygon 150-2 overlapping geographic region 142. Beam polygon 150-1 may represent a first geographic area that at least partially overlaps geographic region 142 (e.g., as projected from a first signal beam of a first satellite) and beam polygon 150-2 may represent a first geographic area that at least partially overlaps geographic region 142 (e.g., as projected from a second signal beam of the first satellite or a second satellite). In this example, CN 20 receives signal measurements associated with the first geographic area that are within the particular range of values during the first sub-period. CN 20 also receives signal measurements associated with the second geographic area that are within the particular range of values during the first sub-period. The other spot beams of constellation 32 did not produce signal measurements within the particular range of values during the first sub-period. As such, CN 20 does not generate beam polygons for the other spot beams of constellation 32 during the first sub-period.

If desired, beam polygon 150-1 may have a first graphical property (e.g., opacity, shade, color, etc.) that is determined by the magnitude of the signal measurements associated with beam polygon 150-1. Similarly, beam polygon 150-2 may have a second graphical property (e.g., opacity, shade, color, etc.) that is determined by the magnitude of the signal measurements associated with beam polygon 150-2. As one example, beam polygon 150-2 may have more opacity, a darker shade, or a darker color if/when the signal measurements (e.g., wireless performance metric data) associated with beam polygon 150-2 have a greater magnitude than the signal measurements (e.g., wireless performance metric data) associated with beam polygon 150-1. On the other hand, beam polygon 150-2 may have less opacity (more transparency), a lighter shade, or a lighter color if/when the signal measurements (e.g., wireless performance metric data) associated with beam polygon 150-1 have a greater magnitude than the signal measurements (e.g., wireless performance metric data) associated with beam polygon 150-2.

As shown in portion 146 of FIG. 8, CN 20 may identify a third beam polygon 150-3 based on signal measurements received for the second sub-period. Beam polygon 150-3 may represent a third geographic area (e.g., a third spot beam 65) where signal measurements were within the particular range of values during the second sub-period. In this example, the other spot beams of constellation 32 did not produce signal measurements within the particular range of values during the second sub-period. As such, CN 20 does not generate other beam polygons corresponding to the other spot beams of constellation 32 during the second sub-period. CN 20 may overlay beam polygon 150-3 with the signal map and the beam polygons 150 already generated for the signal map for the first sub-period. In this example, beam polygon 150-3 at least partially overlaps beam polygon 150-2 (e.g., a portion of beam polygon 150-2 is overlaid with a portion of beam polygon 150-3 in the signal map).

The region where beam polygon 150-3 overlaps beam polygon 150-2 may correspond to a geographic area where the time series data accumulated by CN 20 across the first and second time periods includes the signal measurements of beam polygon 150-2 added or combined with the signal measurements of beam polygon 150-3. The signal map may graphically represent this overlapping portion of beam polygons 150-2 and 150-3 using a graphical indicator (e.g., shade, opacity, color, etc.) indicative of the accumulation, addition, or combination of signal measurements from beam polygons 150-2 and 150-3. The signal map may, for example, display the region where beam polygon 150-2 overlaps beam polygon 150-3 with more opacity, a darker shade, and/or a darker color than the non-overlapping portions of beam polygons 150-2 and 150-3. Put differently, the signal map may graphically represent the accumulation of beam polygons and the corresponding signal measurements associated with the beam polygons across the first and second sub-periods.

As shown in portion 148 of FIG. 8, CN 20 may identify a fourth beam polygon 150-4 based on signal measurements received for the third sub-period. Beam polygon 150-4 may represent a fourth geographic area (e.g., a fourth spot beam 65) where signal measurements were within the particular range of values during the third sub-period. In this example, the other spot beams of constellation 32 did not produce signal measurements within the particular range of values during the third sub-period. As such, CN 20 does not generate other beam polygons corresponding to the other spot beams of constellation 32 during the third sub-period. CN 20 may overlay beam polygon 150-4 with the signal map and the beam polygons 150 already generated for the signal map for the first and second sub-periods. In this example, beam polygon 150-4 at least partially overlaps beam polygons 150-2 and 150-3 (e.g., a portion of beam polygon 150-4 is overlaid with a portion of beam polygon 150-2 and a portion of beam polygon 150-3 in the signal map).

The region where beam polygon 150-4 overlaps beam polygons 150-2 and 150-3 may correspond to a geographic area where the time series data accumulated by CN 20 across the first, second, and third time periods includes the signal measurements of beam polygon 150-4 added or combined with the signal measurements of beam polygons 150-3 and 150-2. The signal map may graphically represent this overlapping portion of beam polygons 150-2, 150-3, and 150-4 using a graphical indicator (e.g., shade, opacity, color, etc.) indicative of the accumulation, addition, or combination of signal measurements from beam polygons 150-2, 150-3, and 150-4. The signal map may, for example, display the region where beam polygon 150-4 overlaps beam polygons 150-2 and 150-3 with more opacity, a darker shade, and/or a darker color than the geographic locations where two or fewer of the beam polygons overlap. Put differently, the signal map may graphically represent the accumulation of beam polygons and the corresponding signal measurements associated with the beam polygons across the first, second, and third sub-periods.

FIG. 8 also illustrates an example of how CN 20 may identify an AOI based on the beam polygons 150 included in the signal map (e.g., while processing operation 112 of FIG. 6). Consider an example in which the predetermined time period ends after the third sub-period. If desired, CN 20 may display portion 148 of FIG. 8 as the signal map (e.g., while processing operation 118 of FIG. 6 or operation 140 of FIG. 7).

CN 20 may, for example, identify AOI 152 as the geographic area where at least N different overlaid beam polygons 150 overlap on the signal map. In the example of FIG. 8, N = 3 and CN 20 may identify an AOI 152 defined by the geographic area where beam polygons 150-2, 150-3, and 150-4 overlap. If desired, CN 20 may generate a graphical indicator identifying AOI 152 in the signal map (e.g., a dashed line extending around the borders or edges of AOI 152 as shown in FIG. 8). In the example of FIG. 8, AOI 152 is located entirely within geographic region 142. However, in practice, AOI 152 may span the border or edge of geographic region 142 and may at least partially overlap one or more other geographic regions.

The boundaries of AOI 152 are independent of the boundaries of geographic region 142. AOI 152 may be a poor performance AOI in implementations where beam polygons 150 correspond to areas where signal measurements exhibited relatively weak wireless performance (e.g., included wireless performance metric data outside a predetermined range of values, greater than a maximum threshold/limit, or less than a minimum threshold/limit). The poor performance AOI may clearly indicate, to a viewer of the signal map, a region where constellation 32 exhibited insufficient levels of cumulative radio-frequency performance over the predetermined time period (e.g., across the first, second, and third sub-periods). This indication may offer greater resolution and/or precision with which to identify the poor performance AOI than in implementations where signal measurements are applied across the entire area spanned by geographic region 142. This may, for example, allow the viewer to easily identify one or more adjustments to make to the communications system to improve network performance (e.g., while processing operation 126 of FIG. 6). If desired, CN 20 may remove, mask out, or filter out some or all of the time series data (signal measurements) associated with AOI 152 from the accumulated time series data (e.g., while processing operation 120 of FIG. 6).

Poor performance AOIs may result from relatively poor radio-frequency propagation and/or channel conditions within their corresponding geographic area, poor satellite coverage of their geographic area, non-idealities in the UE devices of their geographic area, etc. As one example, a poor performance AOI may result from excessive radio-frequency interference from one or more sources within or near the poor performance AOI. Satellite navigation system jamming signals transmitted by one or more jamming devices, as one example, are sometimes close in frequency to the radio-frequency signals conveyed via constellation 32, causing the jamming signals to represent one potential source of radio-frequency interference on communications via constellation 32. As another example, some geopolitical jurisdictions might license portions of the radio-frequency spectrum that are close in frequency to the signals conveyed by constellation 32, forming another potential source of radio-frequency interference on communications via constellation 32. As yet another example, the presence of tall obstacles that impede or block line of sight paths between the ground and satellites 12 in constellation 32 (e.g., tall buildings, trees, mountains, etc.) can also limit radio-frequency performance to form a poor performance AOI.

FIG. 8 also illustrates one example of how AOI 152 may be used to define different alert policies for CN 20. For example, CN 20 may apply a first alert threshold TH1 for triggering issuance of an alert (e.g., at operation 124 of FIG. 6) for locations outside of AOI 152 and may apply a second alert threshold TH2 for triggering issuance of the alert for locations within AOI 152. Threshold TH2 may be harder to meet (e.g., may be more stringent) than threshold TH1. This may help to prevent excessive alerts from being issued for performance issues that occur within AOI 152. For example, the level of wireless performance measured within AOI 152 may need to be weaker (worse) than the level of wireless performance measured outside AOI 152 before an alert is issued.

As one example, if/when a signal measurement that fails to satisfy threshold TH1 is received in a subsequent sub-period for a location outside AOI 152, then CN 20 may issue a corresponding alert. If/when a signal measurement that fails to satisfy threshold TH1 but that still satisfies threshold TH2 is received in the subsequent sub-period for a location within AOI 152, then CN 20 may forego issuing an alert. On the other hand, if/when a signal measurement that fails to satisfy threshold TH2 is received in the subsequent sub-period for a location within AOI 152, then CN 20 may issue a corresponding alert. In this example, a signal measurement that fails to satisfy threshold TH2 also fails to satisfy threshold TH1. As such, if/when a signal measurement that fails to satisfy threshold TH2 is received in the subsequent sub-period for a location outside AOI 152, then CN 20 still issues a corresponding alert.

As another example, AOI 152 may be a strong performance AOI in implementations where beam polygons 150 correspond to areas where signal measurements exhibited relatively strong wireless performance (e.g., included wireless performance metric data within a predetermined range of values, less than a maximum threshold/limit, or greater than a minimum threshold/limit). The strong performance AOI may clearly indicate, to the viewer of the signal map, a region where constellation 32 exhibited sufficient levels of cumulative radio-frequency performance over the predetermined time period. This may, for example, allow the viewer to more easily identify one or more adjustments to make to the communications system to improve network performance (e.g., by shifting resources away from the strong performance AOI to help boost performance in other regions or areas).

The example of FIG. 8 in which the signal map includes accumulated and overlaid beam polygons 150 is illustrative and non-limiting. If desired, the signal map may be a heat map that graphically represents the accumulation of any desired continuous variable in the signal measurements received by CN 20. In these implementations, AOI 152 may represent a strong performance AOI where the accumulated (e.g., added or combined) signal measurements across all three sub-periods is within a predetermined range of values, exceeds a minimum threshold, or is less than a maximum threshold or may represent a poor performance AOI where the accumulated signal measurements across all three sub-periods is outside the predetermined range of values, exceeds the maximum threshold, or is less than the minimum threshold. AOI 152 is sometimes also referred to herein as a target area or region, as a region of interest, or as an impact area or region. If desired, CN 20 may also use TSDOI with relatively strong wireless performance metric data associated with a first geographic area (e.g., in addition to relatively poor wireless performance metric data associated with a second geographic area) as a means to further increase resolution of previously-sampled relatively poor TSDOI (e.g., as a mechanism to increase or sharpen the resolution of an AOI). This may, for example, effectively cancel out areas where sufficient strong and poor performance exist. This concept may also create a positive/negative slider of a continuous variable such as an opacity variable when the data is optionally represented visually (e.g., in the displayed signal map) as another process of post processing the data to increase resolution. For example, one or more strong performance beam polygons associated with strong wireless performance metric data may be used to fine tune a report associated with a nearby poor performance AOI and/or to fine tune the resolution of the poor performance AOI.

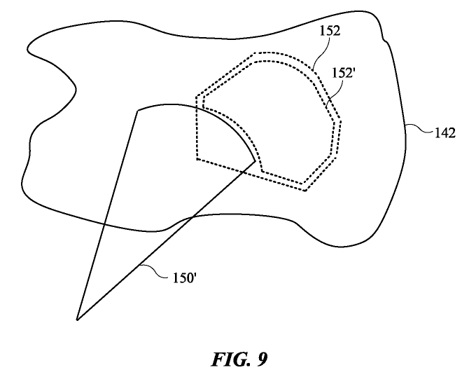

FIG. 9 is a diagram showing one example of how CN 20 may adjust a poor performance AOI 152 based on a strong performance beam polygon of accumulated time series data in the signal map (e.g., while processing operation 122 of FIG. 6). In the example of FIG. 9, AOI 152 is a poor performance AOI. CN 20 may generate a beam polygon 150’ corresponding to signal measurements that are within a range of acceptable wireless performance metric data values (e.g., that include wireless performance metric data that exceeds a minimum wireless performance metric data threshold/limit or that is less than a maximum wireless performance metric data threshold/limit). CN 20 may generate beam polygon 150’ during a sub-period subsequent to the third sub-period of FIG. 8 or may generate beam polygon 150’ during one of the three sub-periods of FIG. 8.

As shown in FIG. 9, CN 20 may shrink, constrain, alter, and/or otherwise adjust the boundary of AOI 152 based on the boundary of beam polygon 150’ (e.g., removing beam polygon 150’ from AOI 152) to produce a modified AOI 152’. CN 20 may may display modified AOI 152’ in the signal map (e.g., while processing operation 118 of FIG. 6), may include information identifying modified AOI 152’ in an output report (e.g., while processing operation 116 of FIG. 6), may remove signal measurements in modified AOI 152’ from the signal measurements in beam polygon 150’ at the locations where AOI 152 overlaps beam polygon 150’ (e.g., while processing operation 120 of FIG. 6), may remove signal measurements in modified AOI 152’ from other signal measurements outside of modified AOI 152’ (e.g., while processing operation 120 of FIG. 6), may issue an alert identifying and/or based on modified AOI 152’ (e.g., while processing operation 124 of FIG. 6), and/or may adjust how constellation 32 communicates with UE devices 10 within modified AOI 152’ (e.g., while processing operation 126 of FIG. 6).

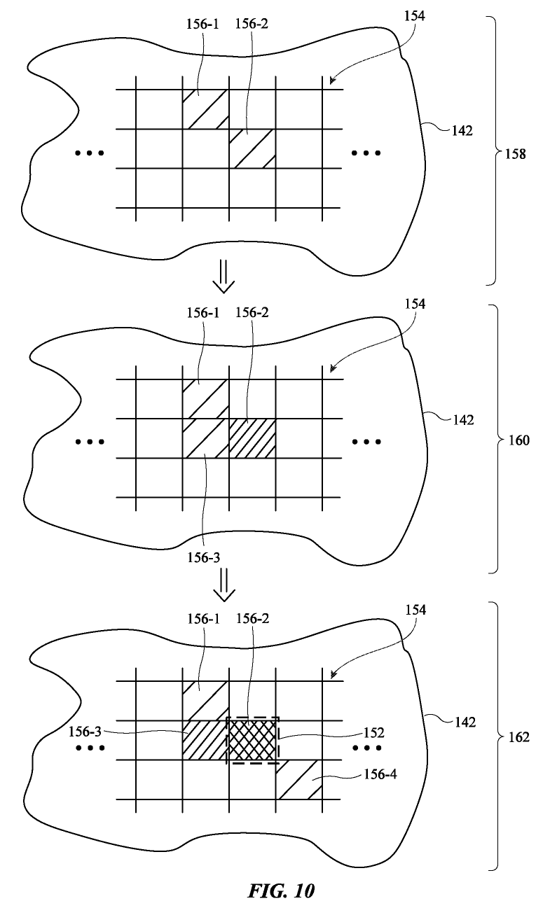

The examples of FIGS. 7-9 in which CN 20 generates a signal map that includes overlaid beam polygons 150 and in which AOI 152 is defined by the overlap of beam polygons 150 is illustrative and non-limiting. In another example, illustrated in FIG. 10, CN 20 may generate the signal map using a repeating grid of cells and may define AOI 152 as including one or more of the cells from the grid of cells.

Portion 158 of FIG. 10 represents the signal map as generated during a first sub-period of the predetermined time period (e.g., after a first iteration of operation 130 of FIG. 7 and operation 106 of FIG. 6). Portion 160 of FIG. 10 represents the signal map as updated during a second sub-period of the predetermined time period (e.g., after a second iteration of operation 130 of FIG. 7 and operation 106 of FIG. 6). Portion 162 of FIG. 10 represents the signal map as updated during a third sub-period of the predetermined time period (e.g., after a third iteration of operation 130 of FIG. 7 and operation 106 of FIG. 6).

As shown in FIG. 10, CN 20 may logically divide region 142 into a pattern or grid of repeating cells 156. Cells 156 may be rectangular (e.g., square, as shown in FIG. 10), hexagonal, or any other desired shape. Each cell 156 may span a respective portion of geographic region 142. CN 20 may accumulate signal measurements in each sub-period within each cell 156 instead of using beam polygons 150 (FIG. 8) that correspond to the location of spot beams 65 (FIG. 3). The accumulation of signal measurements within cells 156 may be similar to the accumulation of signal measurements within beam polygons 150 of FIG. 8.

In FIG. 10, for example, CN 20 may receive signal measurements associated with cells 156-1 and 156-2 during the first sub-period. As shown in portion 158 of FIG. 10, CN 20 may adjust the signal map to include a graphical representation the corresponding signal measurements within cells 156-1 and 156-2 (e.g., by shading cells 156-1 and 156-2, changing the color of cells 156-1 and 156-2, changing the opacity of cells 156-1 and 156-2, etc.). During the second sub-period, illustrated by portion 160 of FIG. 10, CN 20 may receive signal measurements within cells 156-3 and 156-2. CN 20 may adjust the signal map to include a graphical representation of the corresponding signal measurements within cells 156-3 and 156-2 (e.g., accumulating the signal measurements in cell 156-2 for the second sub-period with the signal measurements in cell 156-2 for the first sub-period). During the third sub-period, illustrated by portion 162 of FIG. 10, CN 20 may receive signal measurements within cells 156-3, 156-2, and 156-4. CN 20 may adjust the signal map to include a graphical representation of the corresponding signal measurements within cells 156-3,156-2, and 156-4 (e.g., accumulating the signal measurements in cell 156-2 for the third sub-period with the signal measurements in cell 156-2 for the first and second sub-periods and accumulating the signal measurements in cell 156-3 for the third sub-period with the signal measurements in cell 156-3 for the second sub-period).

CN 20 may identify and indicate AOI 152 from the signal measurements in cells 156 similar to how CN 20 identifies and indicates AOI 152 from the signal measurements in beam polygons 150 of FIG. 8. AOI 152 may, for example, include the cell(s) 156 that include signal measurements (e.g., wireless performance metric data) exceeding or falling below a corresponding threshold level and/or the cell(s) 156 that were accumulated into the signal map during at least N sub-periods. In the example of FIG. 10, N = 3 and CN 20 may identify AOI 152 as including cell 156-2.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

One or more elements described herein (e.g., UE devices 10, satellite 12, gateway 14, CN 20, etc.) may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-12 may be performed using software, firmware, and/or hardware (e.g., dedicated circuitry or hardware). Software code for performing these operations may be stored on non-transitory computer readable storage media (e.g., tangible computer readable storage media) stored on one or more of the components of communications system 38 (e.g., storage circuitry 46 of FIG. 2 or similar storage circuitry on satellites 12, gateways 14, CN 20, network portion 18, etc.). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of communications system 38 (e.g., processing circuitry 48 of FIG. 2 or similar processing circuitry on satellites 12, gateways 14, CN 20, network portion 18, etc.). The processing circuitry may include microprocessors, central processing units (CPUs), application-specific integrated circuits with processing circuitry, or other processing circuitry.

For one or more aspects, at least one of the components set forth in one or more of the preceding figures may be configured to perform one or more operations, techniques, processes, or methods as set forth herein. For example, the control circuitry as described above in connection with one or more of the preceding figures may be configured to operate in accordance with one or more of the examples set forth herein. For another example, circuitry associated with a UE, satellite, gateway, core network, base station, network element, etc. as described above in connection with one or more of the preceding figures may be configured to operate in accordance with one or more of the examples set forth herein.

An apparatus (e.g., an electronic user equipment device, a wireless base station, etc.) may be provided that includes means to perform one or more elements of a method described in or related to any of the methods or processes described herein.

One or more non-transitory computer-readable media comprising instructions to cause an electronic device, upon execution of the instructions by one or more processors of the electronic device, to perform one or more elements of any method or process described herein.

An apparatus comprising logic, modules, or circuitry to perform one or more elements of a method described in or related to any of the method or process described herein.

An apparatus comprising: one or more processors and one or more non-transitory computer-readable storage media comprising instructions that, when executed by the one or more processors, cause the one or more processors to perform the method, techniques, or process as described herein.

A signal, datagram, information element, packet, frame, segment, PDU, or message or datagram may be provided as described in or related to any of the examples described herein.

A signal encoded with data, a datagram, IE, packet, frame, segment, PDU, or message may be provided as described in or related to any of the examples described herein.

An electromagnetic signal may be provided carrying computer-readable instructions, wherein execution of the computer-readable instructions by one or more processors is to cause the one or more processors to perform the method, techniques, or process as described in or related to any of the examples described herein.

A computer program comprising instructions, wherein execution of the program by a processing element is to cause the processing element to carry out the method, techniques, or process as described in or related to any of the examples described herein.

A signal in a wireless network as shown and described herein may be provided.

A method of communicating in a wireless network as shown and described herein may be provided.

A system for providing wireless communication as shown and described herein may be provided.

A device for providing wireless communication as shown and described herein may be provided.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

The foregoing is merely illustrative and various modifications can be made to the described embodiments. The foregoing embodiments may be implemented individually or in any combination.

What is claimed is:

1. A method of operating one or more servers, comprising:
receiving, using a communications interface, first signal measurements of radio-frequency signals that were conveyed, during a first time period, within a geographic region by a constellation of communications satellites;
receiving, using the communications interface, second signal measurements of radio-frequency signals that were conveyed, during a second time period, within the geographic region by the constellation of communications satellites;
generating, using processing circuitry, accumulated signal measurements by combining the first signal measurements with the second signal measurements;
identifying, using the processing circuitry, an area of interest (AOI) based on the accumulated signal measurements; and
performing, using the processing circuitry, an action based on the identified AOI.

2. The method of claim 1, wherein performing the action comprises generating a report that includes the identified AOI and the method further comprises:
transmitting, using the communications interface, the report to a network node.

3. The method of claim 2, wherein the network node comprises a terminal in a network operations center (NOC) of the constellation of communications satellite.

4. The method of claim 2, wherein the network node comprises a terminal of a satellite communications network service provider associated with the one or more servers.

5. The method of claim 1, wherein performing the action comprises:
causing a display to display a signal map, wherein the signal map includes a first graphical indicator of the geographic region and a second graphical indicator of the AOI.

6. The method of claim 5, wherein the signal map comprises:
a first beam polygon associated with the first signal measurements; and
a second beam polygon associated with the second signal measurements, wherein the second graphical indicator overlaps a portion of the signal map that is overlapped by both the first beam polygon and the second beam polygon.

7. The method of claim 1, wherein performing the action comprises:
filtering out, from the accumulated signal measurements, third signal measurements associated with the identified AOI.

8. The method of claim 1, wherein the AOI represents a first portion of the geographic region that is associated with a first portion of the accumulated signal measurements, the first portion of the accumulated signal measurements is outside of a predetermined range of values, and performing the action comprises:
adjusting a shape of the AOI based on a second portion of the geographic region that is associated with a second portion of the accumulated signal measurements, the second portion of the accumulated signal measurements being within the predetermined range of values.

9. The method of claim 1, wherein performing the action includes generating an alert associated with the identified AOI, the method further comprising:
transmitting, using the communications interface, the alert to a network node.

10. The method of claim 1, further comprising:
transmitting, using the communications interface, forward link data to one or more user equipment devices in the geographic region via one or more gateways and the constellation of communications satellites.

11. The method of claim 10, wherein performing the action comprises adjusting transmission of the forward link data based on the identified AOI.

12. The method of claim 10, wherein performing the action comprises transmitting a signal to a network operations center (NOC) associated with the constellation of communications satellites that causes the NOC to adjust the constellation of communications satellites.

13. The method of claim 10, wherein performing the action comprises transmitting a signal to the one or more gateways that causes the one or more gateways to adjust communications with the one or more user equipment devices via the constellation of communications satellites.

14. A method of operating a server, comprising:
receiving, using a communications interface, first signal measurements of radio-frequency signals that were conveyed, during a first time period, within a geographic region by a constellation of communications satellites;
generating, using processing circuitry, a signal map of the geographic region, wherein the signal map includes a first graphical indicator that overlaps the geographic region, the first graphical indicator having a first value of a graphical property that is based on the first signal measurements;
receiving, using a communications interface, second signal measurements of radio-frequency signals that were conveyed, during a second time period, within the geographic region by the constellation of communications satellites;
updating, using the processing circuitry, the signal map to include a second graphical indicator overlapping the geographic region, wherein the second graphical indicator has a second value of the graphical property that is based on the second signal measurements; and
transmitting, using the communications interface, the signal map to an electronic device having a display that displays the signal map.

15. The method of claim 14, wherein a first portion of the first signal measurements is generated by a first set of devices at first geographic coordinates within the geographic region, a second portion of the first signal measurements is generated by a second set of devices at second geographic coordinates within the geographic region, a third portion of the second signal measurements is generated by a third set of devices at third geographic coordinates within the geographic region, a fourth portion of the second signal measurements is generated by a fourth set of devices at fourth geographic coordinates within the geographic region, the first graphical indicator overlaps the first set of geographic coordinates in the signal map, and the second graphical indicator overlaps the second set of geographic coordinates in the signal map.

16. The method of claim 15, wherein the first portion of the first signal measurements is within a predetermined range of values, the second portion of the first signal measurements is outside the predetermined range of values, the third portion of the second signal measurements is within the predetermined range of values, and the fourth portion of the second signal measurements is outside the predetermined range of values.

17. The method of claim 16, wherein:
the first graphical indicator comprises a first beam polygon projected onto the signal map,
the second graphical indicator comprises a second beam polygon projected onto the signal map,
the second beam polygon overlaps the first beam polygon within an overlap region of the signal map,
the first beam polygon has the first value of the graphical property outside of the overlap region,
the second beam polygon has the second value of the graphical property outside of the overlap region,
the first value of the graphical property is proportional to a magnitude of the first portion of the first signal measurements,
the second value of the graphical property is proportional to a magnitude of the third portion of the second signal measurements,
the overlap region has a third value of the graphical property,
the third value of the graphical property is proportional to a combination of the first value and the second value of the graphical property, and
the graphical property comprises an opacity level, a shade, or a color.

18. The method of claim 16, wherein:
the signal map is divided into a repeating pattern of cells,
the first graphical indicator comprises a first set of cells in the repeating pattern of cells,
the second graphical indicator comprises a second set of cells in the repeating pattern of cells,
the first set of cells includes an overlapping cell with the second set of cells,
the first set of cells has the first value of the graphical property outside of the overlapping cell,
the first value of the graphical property is proportional to a magnitude of the first portion of the first signal measurements,
the second set of cells has the second value of the graphical property outside of the overlapping cells,
the second value of the graphical property is proportional to a magnitude of the third portion of the second signal measurements,
the overlapping cell has a third value of the graphical property,
the third value of the graphical property is proportional to a combination of the first value and the second value of the graphical property, and
the graphical property comprises an opacity level, a shade, or a color.

19. A method of operating a core network in communication with a set of user equipment (UE) devices in a geographic region via a constellation of communications satellites and at least one gateway, the method comprising:
receiving, using a communications interface, wireless performance metric data associated with radio-frequency signals conveyed between the constellation of communications satellites and the UE devices during a series of sub-periods of a predetermined time period, wherein each sub-period in the series comprises at least one system cycle of the constellation of communications satellites and the predetermined time period is at least one minute;
generating, using processing circuitry, accumulated data by accumulating the wireless performance metric data for different locations within the geographic region across the predetermined time period; and
causing, using the processing circuitry and the communications interface, an adjustment to communications via the constellation of communications satellites based on the accumulated data.

20. The method of claim 19, further comprising:
identifying, using the processing circuitry, an area of interest (AOI) overlapping the geographic region based on the accumulated data, wherein
the AOI includes accumulated wireless performance metric data that is outside of a predetermined range, and
the accumulated data includes, outside of the AOI, accumulated wireless performance metric data that is within the predetermined range; and
causing, using the processing circuitry and the communications interface, the adjustment to communications via the constellation of communications satellites based on the identified AOI.
